(19) United States
(12) Patent Application Publication
(10) Pub. No.: US 2026/0124892 A1
(43) Pub. Date: May 7, 2026

(54) BATTERY PACK MODULE FOR HAUL TRUCK

(71) Applicant: Cummins Inc., Columbus, IN (US)

(72) Inventor: Kieran J. Richards, Northamptonshire (GB)

(21) Appl. No.: 18/934,951

(22) Filed: Nov. 1, 2024

Related U.S. Application Data
(63) Continuation of application No. 18/934,913, filed on Nov. 1, 2024.

(51) Int. Cl. B60K 1/04; B60L 50/64; B60R 16/02; H01M 10/613; H01M 10/625; H01M 50/204; H01M 50/249; H01M 50/258; H01M 50/298; H01M 50/51; H01M 50/512

(52) U.S. Cl. CPC B60K 1/04; B60L 50/64; B60R 16/0207; H01M 10/613; H01M 10/625; H01M 50/204; H01M 50/249; H01M 50/258; H01M 50/298; H01M 50/51; H01M 50/512; H01M 2220/20

(57) ABSTRACT

A battery pack module for heavy equipment vehicles, such as mining trucks, is presented herein. The battery pack module may include multiple layers of battery trays, each try including multiple battery packs. The battery pack module may further include a cooling line system and a battery cabling system that each are connected to the battery pack layers in parallel. The battery pack module may have a unibody design to reduce weight and cost of manufacturing.

### CROSS-REFERENCE TO RELATED APPLICATIONS

The present application claims the benefit of priority to and is a continuation of U.S. patent application Ser. No. 18/934,913, filed Nov. 1, 2024, which is incorporated herein by reference in its entirety.

### TECHNICAL FIELD OF THE PRESENT DISCLOSURE

The present disclosure relates generally to a battery pack module for a haul truck, such as a mining truck. In particular, the present disclosure relates to a battery pack module including a unibody structure and a plurality of battery pack layers.

### BACKGROUND OF THE PRESENT DISCLOSURE

Large equipment vehicles, such as haul trucks, mining vehicles, cranes, bulldozers, etc., may require a large power source to accommodate the workload and/or sheer size of the vehicle. The large equipment vehicles may be equipped with battery packs to increase peak power output during ascending, aid in breaking, recover energy when descending, and otherwise provide power to the engine. Due to the size of large equipment vehicles, considerably large battery pack systems are necessary to operate the large equipment vehicles. The large battery pack systems necessary to accommodate the power requirements for operation may be heavy and dimensionally difficult to fit onto standard vehicle architectures.

### SUMMARY OF THE DISCLOSURE

The present disclosure provides a layered battery pack module configured for mounting on a mining truck. The layered battery pack module including: a support structure including a first support beam and a second support beam, each of the first support beam and the second support beam including a vertical portion and a horizontal portion, a distal end of the vertical portion coupled to a distal end of the horizontal portion so that the vertical portion and the horizontal portion define an angle therebetween; a first side plate coupled to the vertical portion of the first support beam and the horizontal portion of the first support beam; a second side plate coupled to the vertical portion of the second support beam and the horizontal portion of the second support beam, the second side plate being positioned opposite of the first side plate; and a plurality of battery pack layers defined between the first side plate and the second side plate. In another embodiment, the layered battery pack module further includes a plurality of battery pack trays. Each battery pack tray of the plurality of battery pack trays removably coupled to one corresponding battery pack layer of the plurality of battery pack layers. In another embodiment, each battery pack tray of the plurality of battery pack trays includes: a battery tray surface; and at least one battery pack coupled to the battery tray surface. Each battery pack tray of the plurality of battery pack trays is configured to slide onto a sliding surface of the one corresponding battery pack layer of the plurality of battery pack layers. Further, the layered battery pack module further includes a first end plate coupled to a distal end of the battery tray surface and a second end plate coupled to a proximal end of the battery tray surface such that the first end plate and the second end plate extend in a direction perpendicular to the battery tray surface. Further, each battery pack tray of the plurality of battery pack trays includes three battery packs.

In yet another embodiment, the sliding surface of each battery pack layer of the plurality of battery pack layers includes a first support rail coupled to the first side plate extending a length of the first side plate and a second support rail coupled to the second side plate opposite of and parallel to the first support rail, the second support rail extending a length of the second side plate. Further, each battery pack tray of the plurality of battery pack trays is configured to slide onto the first support rail and the second support rail of the corresponding battery pack layer of the plurality of battery pack layers. In yet another embodiment, the layered battery pack tray further includes a top stiffening tray coupled to an upper portion of each of the first side plate and the second side plate. In a different embodiment, the layered battery pack tray further includes: a first mounting pin coupled to a proximal end of the vertical portion of the first support beam; and a second mounting pin coupled to a proximal end of the vertical portion of the second support beam. In another embodiment, the layered battery pack tray further includes a back plate extending between the first side plate and the second side plate, the back plate including a mounting brace configured to couple to a lower mount of the mining truck.

In another embodiment, the plurality of battery pack layers includes seven battery pack layers. In another embodiment, each of the first side plate and the second side plate include a bottom mounting surface on a bottom portion of the first side plate and the second side plate and an upper mounting surface on an upper portion of the first side plate and the second side plate. Further, at least one of a mud flap, a water guard, and a fluid seal are removably coupled to at least one of the bottom mounting surface and the upper mounting surface. Further still, the layered battery pack module further includes a top mounting surface coupled to a top portion of each of the first side plate, the second side plate, and a back plate extending between the first side plate and the second side plate, the top portion being above each of the upper portion of the first side plate and the second side plate and an upper portion of the back plate. The layered battery pack further includes a first service access panel coupled to the first side plate; a second service access panel and a third service access panel coupled to the second side plate; a fourth service access panel coupled to a front plate of the battery pack module; and a fifth service access panel coupled to a top plate of the battery pack module, the top plate being coupled to the top mounting surface. In yet another embodiment, the layered battery pack module has a unibody design.

The present disclosure further provides a layered battery pack module configured for mounting on a mining truck. The layered battery pack module includes: a first side plate corresponding with a first side of the layered battery pack module; a second side plate corresponding with a second side of the layered battery pack module; a plurality of battery pack layers between the first side plate and the second side plate, each battery pack layer of the plurality of battery pack layers defining a sliding surface; and a plurality of battery pack trays, each battery pack tray of the plurality of battery pack trays configured to be removably received by a corresponding battery pack layer of the plurality of battery pack layers. Each battery pack tray of the plurality of battery pack trays includes: a battery tray surface; and at least one battery pack coupled to the battery tray surface.

In another embodiment, the layered battery pack module further includes a first end plate coupled to a distal end of the battery tray surface and a second end plate coupled to a proximal end of the battery tray surface such that the first end plate and the second end plate extend in a direction perpendicular to the battery tray surface. Further, the first end plate and the second end plate each include a tray lifting feature. In another embodiment, the sliding surface of each battery pack layer of the plurality of battery pack layers is defined by: a first support rail coupled to the first side plate and extending a length of the first side plate; and a second support rail coupled to the second side plate and extending a length of the second side plate.

In yet another embodiment, each battery pack tray of the plurality of battery pack trays includes a first sliding rail configured to slideably couple to the first support rail and a second sliding rail configured to slideably couple to the second support rail. In a different embodiment, each battery pack tray of the plurality of battery pack trays is configured to slide along the sliding surface of the corresponding battery pack layer in a direction away from a chassis of the mining truck. In a further embodiment, the layered battery pack module further includes a locking mechanism to hold each battery pack tray of the plurality of battery pack trays in a position relative to the corresponding battery pack layer.

In another embodiment, each battery pack tray of the plurality of battery pack trays is configured to slide into one battery pack layer of the plurality of battery pack layers. In yet another embodiment, the plurality of battery pack layers includes seven battery pack layers. In another embodiment, the plurality of battery packs includes three battery packs. In a different embodiment, the first end plate and the second end plate are coupled to the battery tray surface such that a mounting lip of the first end plate and the second end plate extends a distance parallel to the battery tray surface. In yet another embodiment, each battery pack tray of the plurality of battery pack trays includes two stiffening ridges, each stiffening ridge of the two stiffening ridges extending a length of the battery pack tray between the distal and proximal ends, wherein the two stiffening ridges are configured to reduce flexing of the battery pack. In another embodiment, the battery tray surface includes at least one opening configured to allow fluid to drain through the battery pack tray.

In another embodiment, the layered battery pack tray further includes a support structure including a first support beam and a second support beam, each of the first support beam and the second support beam including a vertical portion and a horizontal portion, wherein a distal end of the vertical portion couples to a distal end of the horizontal portion to form an angle therebetween. Further, the battery pack tray includes: a first mounting pin coupled to a proximal end of the vertical portion of the first support beam; and a second mounting pin coupled to a proximal end of the vertical portion of the second support beam.

In another embodiment, the layered battery pack module further includes: a back panel having a mounting brace; a first mounting pin coupled to the first side of the layered battery pack module; and a second mounting pin coupled to the second side of the layered battery pack module. Further, the mounting brace is configured to couple to a lower mount of the mining truck. Further still, the battery pack module is configured to be mounted to the mining truck via the mounting pins.

In another embodiment, the layered battery pack module further includes cooling lines. The cooling lines including: a primary cooling supply line, the primary cooling supply line fluidly coupled to a coolant fluid source; a primary return cooling line; and a plurality of battery pack layer cooling lines fluidly coupled to the primary supply cooling line and the primary return cooling line in parallel, each battery pack layer cooling line of the plurality of battery pack layer cooling lines corresponding to one battery pack layer of the plurality of battery pack layers. Further, each battery pack layer cooling line of the plurality of battery pack layer cooling lines includes: a layer supply line fluidly coupled to a plurality of layer supply branch lines in parallel, each layer supply branch line of the plurality of layer supply branch lines corresponding with one battery pack of the plurality of battery packs; and a layer return line fluidly coupled to a plurality of layer return branch lines in parallel, each layer return branch line of the plurality of layer return branch lines corresponding with one battery pack of the plurality of battery packs. Further still, each battery pack layer cooling line of the plurality of battery pack layer cooling lines includes: a layer supply line fluidly coupled to a plurality of layer supply branch lines in series, each layer supply branch line of the plurality of layer supply branch lines corresponding with one battery pack of the plurality of battery packs; and a layer return line fluidly coupled to a plurality of layer return branch lines in series, each layer return branch line of the plurality of layer return branch lines corresponding with one battery pack of the plurality of battery packs.

In another embodiment, the layered battery pack module further includes battery cabling lines, the battery cabling lines including: a primary cabling line; and a plurality of layer cabling lines electronically coupled to the primary cabling line in parallel. Each layer cabling line of the plurality of layer cabling lines correspond to one battery pack layer of the plurality of battery pack layers. Further, each layer cabling line of the plurality of layer cabling lines corresponds to one battery pack layer of the plurality of battery pack layers and electronically couples to one battery pack of the plurality of battery packs such that the plurality of battery packs within one common battery pack layer of the plurality of battery pack layers are connected in parallel. In another embodiment, the layered battery pack module has a unibody design.

The present disclosure also provides a layered battery pack module configured for mounting to a mining truck. The layered battery pack module includes a first support beam having a first end portion and a second end portion; a first plate coupled to the first support beam to form a first sidewall; a second plate coupled to the first support beam to form a back panel, the second plate including a mounting brace positioned nearer the second end portion of the first support beam than the first end portion of the first support beam, and the mounting brace configured to couple to a lower mount of a chassis of a vehicle; and a first pivot pin coupled to and extending from one of the first end portion of the first support beam than the second end portion of the first support beam, the first pivot pin configured to be received by a pin receiving mount of the chassis of the vehicle. In another embodiment, the layered battery pack module further includes: a second support beam having a first end portion and a second end portion, the second support beam coupled to the second plate opposite the first support beam; a third plate coupled to the second support beam to form a second sidewall; and a second pivot pin coupled to and extending from one of the first end portion of the second support beam and the third plate nearer the first end portion of the second support beam than the second end portion of the second support beam, the second pivot pin configured to be received by the pin receiving mount of the chassis of the vehicle.

In yet another embodiment, the first pivot pin extends in a generally perpendicular direction relative to the first support beam or the first plate. In another embodiment, the mounting brace is configured to removably couple to the lower mount of the chassis of the vehicle. In another embodiment, the lower mount to the chassis of the vehicle includes a vibration mitigation element.

The present disclosure further provides a vehicle having a layered battery pack module. The vehicle includes: a first wheel coupled to a first side of a chassis at a first forward position; a second wheel coupled to the first side of the chassis at a first rearward position; a support structure of a battery pack module coupled to the first side of the chassis at a position between the first wheel and the second wheel; and a vertical operating cable extending vertically along at least a portion of the first end of the battery pack module to a first access point. The battery pack module including a plurality of battery pack layers in a vertical arrangement, each battery pack layer of the plurality of battery pack layers including at least one battery pack. Each battery pack layer of the plurality of battery pack layers includes a tray operating line, each tray operating line coupled to each battery pack of the at least one battery pack of the corresponding battery pack layer, and each tray operating line extending to a first end of the battery pack module. The first access point is positioned within an access zone defined behind the first wheel.

In another embodiment, each battery pack layer includes a plurality of battery packs, and each tray operating line couples each battery pack of the plurality of battery packs of the corresponding battery pack layer in series. In a further embodiment, each battery pack layer includes a plurality of battery packs, and each tray operating line couples each battery pack of the plurality of battery packs of the corresponding battery pack layer in parallel. In yet another embodiment, each tray operating line and the vertical operating cable are electronic cabling lines. Further, each tray operating line is coupled to the vertical operating cable via a high voltage electrical interface box.

In another embodiment, the first access point is a high voltage electrical box. In yet another embodiment, the first access point is positioned on an upper mounting surface of the battery pack module. In a further embodiment, each tray operating line and the vertical operating cable are cooling lines. In another embodiment, the access point is accessible from the access zone via a removable service panel of the battery pack module.

The present disclosure provides a battery pack module for a vehicle. The battery pack module includes: a front panel; a back panel positioned opposite of the front panel; a first side panel extending between the front panel and the back panel, the first side panel having a first service access; and a plurality of battery pack layers in a vertical arrangement within the front panel. The back panel, and the first side panel, each battery pack layer of the plurality of battery pack layers including a battery pack. Each battery pack layer of the plurality of battery pack layers includes a tray operating line. The tray operating line removably coupled to the battery pack and being accessible via the first service access for disconnecting the tray operating line from the battery pack. In another embodiment, the service access is one of a door, a portal, or a flap. Further, the battery pack module further includes: a second side panel extending between the front panel and the back panel opposite the first side panel; a top panel extending between the front panel, the back panel, the first side panel, and the second side panel; and a second access corresponding with one of the front panel, the back panel, the second side panel, and the top panel. In another embodiment, the tray operating line extends to a first end of the battery pack module. Further, the battery pack module further includes a vertical operating cable extending vertically along at least a portion of the first end of the battery pack module to a third access.

In another embodiment, each battery pack layer includes a plurality of battery packs, and the tray operating line couples each battery pack of the plurality of battery packs of the corresponding battery pack layer in series. In a further embodiment, each battery pack layer includes a plurality of battery packs, and the tray operating line couples each battery pack of the plurality of battery packs of the corresponding battery pack layer in parallel.

In yet another embodiment, the tray operating line is an electronic cabling line. In another embodiment, the tray operating line includes: a layer supply branch cooling line fluidly coupled to a layer supply cooling line, the layer supply cooling line corresponding with a battery pack layer of the plurality of battery pack layers; and a layer return branch cooling line fluidly coupled to a layer return cooling line, the layer return cooling line corresponding with the battery pack layer of the plurality of battery pack layers. Further, the battery pack module includes a plurality of battery packs, a plurality of layer supply branch cooling lines, and a plurality of layer return branch cooling lines so that: each layer supply branch cooling line of the plurality of layer supply branch cooling lines corresponds with one battery pack of the plurality of battery packs; each layer return branch cooling line of the plurality of layer return branch cooling lines corresponds with one battery pack of the plurality of battery packs; the layer supply cooling line is fluidly coupled to each layer supply branch cooling line of the plurality of layer supply branch cooling lines; and the layer return cooling line is fluidly coupled to each layer return branch cooling line of the plurality of layer return branch cooling lines. Further still, the battery pack module includes: a primary cooling supply line, the primary cooling supply line fluidly coupled to a coolant fluid source and the layer supply cooling line; and a primary cooling return line, the primary cooling return line fluidly coupled to the layer supply cooling line.

The present disclosure provides a battery pack tray for a layered battery pack module. The battery pack tray includes: a tray, a first end plate, and a second end plate. The tray includes a tray surface, a distal end, and a proximal end; a first side, and a second side. The tray configured to support at least one battery pack on the tray surface, the first side including a first sliding surface, and the second side including a second sliding surface. The first end plate coupled to the distal end of the tray and extending in a direction perpendicular to the tray surface. The second end plate coupled to the proximal end of the tray. The first end plate and the second end plate each includes a stiffening lip that extends from the first end plate and the second end plate parallel to the tray surface. In another embodiment, the battery pack tray is configured to slide into a layered battery pack module on the first sliding surface and the second sliding surface. In a further embodiment, the first sliding surface is defined by a first sliding rail and the second sliding surface is defined by a second sliding rail. In yet another embodiment, each of the first end plate and the second end plate includes a tray lifting opening.

In further embodiment, the battery pack tray further includes a first stiffening ridge extending a length of the first side of the tray between the distal end of the tray and the proximal end of the tray, and a second stiffening ridge extending a length of the second side of the tray between the distal end of the tray and the proximal end of the tray. In another embodiment, the tray surface includes a first tray support joist extending between the distal end of the tray and the proximal end of the tray and a second tray support joist extending between the first side of the tray and the second side of the tray. Further, the first tray support joist and the second tray support joist define a plurality of tray surface openings, the tray surface openings configured to allow fluid to drain through the slidable battery pack tray. Further still, the first tray support joist and the second tray support joist are included in a plurality of tray support joists, the plurality of tray support joists forming a lattice structure across the tray surface.

In another embodiment, the battery pack tray further includes a cooling line mounting bracket configured to support a parallel cooling line, the parallel cooling line coupling to the at least one battery pack on the tray surface. In yet another embodiment, the battery pack tray further includes a high voltage electrical interface box configured to couple to a parallel cabling line coupled to the at least one battery pack on the tray surface.

The present disclosure also provides a layered battery pack module for a mining truck. The layered battery pack module includes a plurality of battery pack trays, a coolant line system, and a battery pack cabling system. Each battery pack tray of the plurality of battery pack trays removably coupled to a corresponding battery pack layer of a plurality of battery pack layers. Each battery pack tray of the plurality of battery pack trays including at least one battery pack. The coolant line system is configured to cool the at least one battery pack. The coolant line system including: a primary supply cooling line, the primary supply cooling line fluidly coupled to a coolant fluid source; a primary return cooling line; and a plurality of battery pack layer cooling lines fluidly coupled to the primary supply cooling line and the primary return cooling line. Each one of the plurality of battery pack layer cooling lines corresponding to one battery pack layer of the plurality of battery pack layers. The battery cabling system configured to transport current from the at least one battery pack of each battery pack layer of the plurality of battery pack layers to the mining truck. The battery cabling system including; a primary cabling line; and a plurality of layer cabling lines electronically coupled to the primary cabling line. E ach of the plurality of layer cabling lines corresponding to one battery pack layer of the plurality of battery pack layers.

In another embodiment, each battery pack layer cooling line of the plurality of battery pack layer cooling lines is fluidly coupled to the primary supply cooling line and the primary return cooling line in parallel. In yet another embodiment, each battery pack layer cooling line of the plurality of battery pack layer cooling lines is fluidly coupled to the primary supply cooling line and the primary return cooling line in series. In another embodiment, each layer cabling line of the plurality of layer cabling lines is electronically coupled to the primary cabling line in parallel. In a further embodiment, each layer cabling line of the plurality of layer cabling lines is electronically coupled to the primary cabling line in series.

In another embodiment of the battery pack module, each battery pack tray of the plurality of battery pack trays each include: a battery tray surface and a plurality of battery support joists. The tray surface defined by: a first side; a second side parallel to the first side; a distal end connecting the first side to the second side; and a proximal end connecting the first side to the second side, the proximal end spaced apart from the distal end by the first side and the second side. The plurality of support joists extending from at least one of: the first side to the second side; and the distal end to the proximal end. Further, the at least one battery pack is coupled to at least one battery support joists of the plurality of battery support joists.

In another embodiment, each battery pack layer includes a plurality of battery packs and each battery pack layer cooling line of the plurality of battery pack layer cooling lines includes: a layer supply line fluidly coupled to a plurality of layer supply branch lines in parallel, each of the plurality of layer supply branch lines corresponding with one battery pack of the plurality of battery packs; and a layer return line fluidly coupled to a plurality of layer return branch lines in parallel, each of the plurality of layer return branch lines corresponding with one battery pack of the plurality of battery packs.

In yet another embodiment, each battery pack layer includes a plurality of battery packs and each battery pack layer cooling line of the plurality of battery pack layer cooling lines includes: a layer supply line fluidly coupled to a plurality of layer supply branch lines in series, each of the plurality of layer supply branch lines corresponding with one battery pack of the plurality of battery packs; and a layer return line fluidly coupled to a plurality of layer return branch lines in series, each of the plurality of layer return branch lines corresponding with one battery pack of the plurality of battery packs. In a further embodiment, each battery pack layer includes a plurality of battery packs and each layer cabling line of the plurality of layer cabling lines electronically couples the plurality of battery packs in parallel. In another embodiment, each battery pack layer includes a plurality of battery packs and each layer cabling line of the plurality of layer cabling lines electronically couples the plurality of battery packs in series.

The present disclosure provides a method of servicing a layered battery pack module on a mining truck. The method includes: removing a first services access panel from a first side of the layered battery pack module; disconnecting a battery cabling from a high voltage electrical interface box of a first battery pack layer, which interrupts current flowing from any one battery pack of a plurality of battery packs on a battery pack tray of the first battery pack layer; removing an end service access panel from a front side of the layered battery pack module; and sliding the battery pack tray out of the layered battery pack module. In another embodiment, the method further includes uncoupling a tray locking plate from a battery pack tray end plate. In yet another embodiment, the method further includes at least one of: sliding the battery pack tray into the battery pack module; coupling a tray locking plate to a battery pack tray end plate; coupling the end service access panel to the front side of the layered battery pack module; electronically connecting the battery cabling to the high voltage electrical interface box of the first battery pack layer; and coupling the first service access panel to the first side of the layered battery pack module. In yet another embodiment, the method further includes removing a second service access panel from at least one of a second side or a top side of the layered battery pack module. In a further embodiment, sliding the battery pack tray out of the layered battery pack module includes: inserting a tool into a lifting feature on a distal end of the battery pack tray; and using the tool to slide the battery pack tray out of the battery pack module.

### BRIEF DESCRIPTION OF THE DRAWINGS

The above-mentioned and other features and advantages of this disclosure, and the manner of obtaining them, will become more apparent, and will be better understood by reference to the following description of the exemplary embodiments taken in conjunction with the accompanying drawings, wherein:

FIG. 1 is a schematic top-down illustration of an architecture arrangement of components of a mining truck;

FIG. 2 illustrates a schematic top-down illustration of an architecture arrangement of components of a mining truck;

FIG. 3 illustrates a top-down schematic illustration of a battery pack module relative to a chassis and a plurality of wheels of a mining truck with the plurality of wheels in a first configuration;

FIG. 4 illustrates a top-down schematic illustration of the battery pack module of FIG. 3 with the plurality of wheels in a second configuration;

FIG. 5 is a perspective view of support structures of a battery pack module of the present disclosure;

FIG. 6A is a perspective view of side plates, support structures, and support plates of a battery pack module of the present disclosure;

FIG. 6B is a perspective view of the battery pack module of FIG. 6A, further including support rails, an upper mounting surface, a top cover mounting surface, and a bottom mounting surface;

FIG. 7A is a perspective view of locking plates of a battery pack module of the present disclosure;

FIG. 7B is a perspective view of the battery pack module of FIG. 7A with the locking plates removed and a battery tray removed from the battery pack module;

FIG. 8A is a top perspective view a battery tray of the present disclosure;

FIG. 8B is a bottom perspective view of the battery tray FIG. 8A;

FIG. 8C is a close-up end view of the battery tray of FIGS. 8A-8B;

FIG. 9 is a first perspective view of an exposed first side of a battery pack module of the present disclosure;

FIG. 10 is a second perspective view the exposed first side of the battery pack module of FIG. 9;

FIG. 11A is a perspective view of a first side of a battery pack module of the present disclosure;

FIG. 11B is a perspective view of a second side of the battery pack module of FIG. 11A; and

FIG. 11C is a perspective view of a third side of the battery pack module of FIGS. 11A-11B.

Corresponding reference characters indicate corresponding parts throughout the several views. Although the drawings represent embodiments of various features and components according to the present disclosure, the drawings are not necessarily to scale, and certain features may be exaggerated in order to better illustrate and explain the present disclosure. The exemplification set out herein illustrates an embodiment of the disclosure, and such an exemplification is not to be construed as limiting the scope of the disclosure in any manner.

### DETAILED DESCRIPTION OF THE DRAWINGS

For the purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art may utilize their teachings.

The terms “couples”, “coupled”, “coupler” and variations thereof are used to include both arrangements wherein the two or more components are in direct physical contact and arrangements wherein the two or more components are not in direct contact with each other (e.g., the components are “coupled” via at least a third component), but yet still cooperate or interact with each other.

In some instances throughout this disclosure and in the claims, numeric terminology, such as first, second, third, fourth, etc., is used in reference to various components of features. Such use is not intended to denote an ordering of the components or features. Rather, numeric terminology is used to assist the reader in identifying the components or features being referenced and should not be narrowly interpreted as providing a specific order of components or features.

While the disclosure herein is provided in terms of a “mining truck”, it is understood that the features described herein may apply to other vehicles, including heavy equipment such as cranes, bulldozers, excavators, etc., locomotives, and other appropriate vehicles.

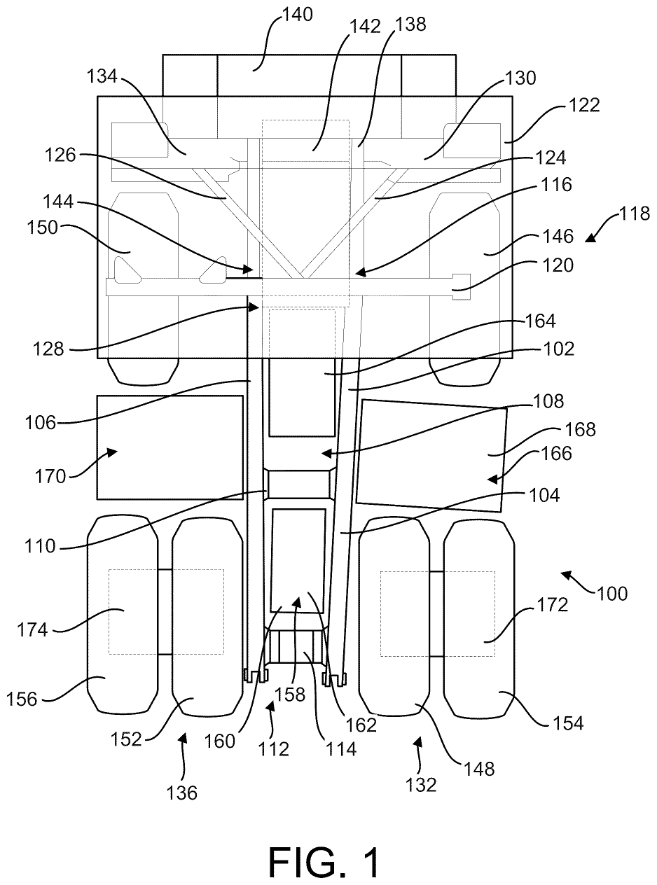

A schematic architecture of an example mining truck 100 is illustrated in FIG. 1. As shown, mining truck 100 may generally be built on and/or around chassis 102. Chassis 102 may include a first frame member 104 and a second frame member 106 extending longitudinally from a first end portion of the chassis, including a first end of the chassis, to a second end portion of the chassis, including a second end of the chassis, to at least partially define a length of mining truck 100. First frame member 104 and second frame member 106 may be spaced apart to form a space 108 therebetween, with a central crossbeam 110 extending from first frame member 104 to second frame member 106 across space 108, generally defining a rear chassis region 112. A rear crossbeam 114 may extend from first frame member 104 to second frame member 106 across space 108 at the rear of chassis 102, and a horse collar 116 may connect first frame member 104 and second frame member 106 within a forward region 118 of chassis 102.

A third frame member 120 may extend across the top of horse collar 116 and beyond the diameter of horse collar 116 to form a support for a deck 122 (FIG. 1). A first supplemental frame member 124 and a second supplemental frame member 126 may each extend diagonally from a central portion 128 of third frame member 120 above horse collar 116 in opposite directions so that first supplemental frame member 124 may connect to a first support plate 130 and second supplemental frame member 126 may connect to a second support plate 134. First support plate 130 may also connect to first frame member 104 on a first side 132 of chassis 102, and second support plate 134 may also connect to second frame member 106 on a second side 136 of chassis 102.

A forward crossbeam 138 may extend from first frame member 104 to second frame member 106 in general alignment with first support plate 130 and second support plate 134. A support extension 140 may extend forward of forward crossbeam 138. An engine 142 may be positioned within an opening 144 defined by horse collar 116. A traction alternator and/or gearbox may be mounted rearward of engine 142 within area 164.

Wheels 146, 148, 150, and 152 may be mounted to chassis 102 via respective axles (not shown). For example, as shown, first wheel 146 may be mounted at a forward position in forward region 118 on first side 132 of chassis 102. Second wheel 148 may be mounted at a rearward position in rear region 112 on first side 132 of chassis 102. Third wheel 150 may be mounted at a forward position in forward region 118 on second side 136 of chassis 102. Fourth wheel 152 may be mounted at a rearward position in rear region 112 on second side 136 of chassis 102. In some embodiments, mining truck 100 may include a fifth wheel 154 mounted adjacent to second wheel 148 at a rearward position in rear region 112 on first side 132 of chassis 102. Some embodiments may additionally include a sixth wheel 156 mounted adjacent to fourth wheel 152 at a rearward position in rear region 112 on second side 136 of chassis 102. First wheel 146 and third wheel 150 may be mounted at a position generally corresponding to third frame member 102.

A rear region space 158 defined between first frame member 104 and second frame member 106 within rear chassis region 112, and at least partially defined between second wheel 148 and fourth wheel 152, may be sized and shaped to receive a vehicle subsystem 160. For example, as shown in FIG. 1, vehicle subsystem 160 may include an aftertreatment system 162. In other embodiments, vehicle subsystem 160 may include a battery module, a fuel tank, a powertrain support subsystem, an exhaust muffler, an exhaust silencer, or any other vehicle subsystems necessary or otherwise desired for operation of mining truck 100. As described herein, an exhaust muffler and an exhaust silencer may be similar or the same components intended to quiet an exhaust by some volume. In other embodiments, rear region space 158 may be free of any vehicle subsystems or components.

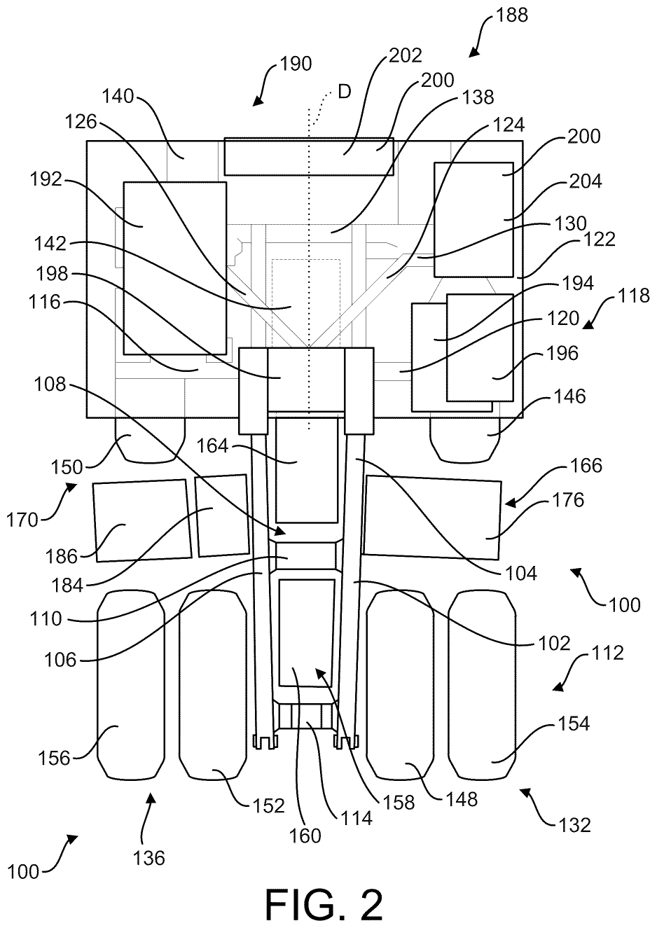

Referring additionally to FIG. 2, as discussed above, deck 122 may be supported at a forward position by chassis 102. Deck 122 may include a first region 188 associated with a first side of deck 122 corresponding with first side 132 of chassis 102 and a second region 190 associated with a second side of deck 122 corresponding with second side 136 of chassis 102. First region 188 and second region 190 are illustrated by dividing line “D”. An operator cab 192 may be arranged within second region 190 of deck 122. Operator cab 192 is configured to house an operator during operation of mining truck 100, along with controls necessary or desired for said operation of mining truck 100.

A resistor grid 194 may be arranged within first region 188 of deck 122 and may be positioned at a generally rearward position of first region 188 of deck 122. A DC/DC system 196 may be positioned on top of resistor grid 194 so that DC/DC system 196 and resistor grid 194 are in a vertically stacked arrangement. In other embodiments, DC/DC system 196 may be positioned in a forward position relative to resistor grid 194.

An inverter cabinet 198 may be positioned at least partially in first region 188 of deck 122 and at least partially in second region 190 of deck 122. For example, inverter cabinet 198 may be equally positioned in first region 188 and second region 190 or, in some embodiments, be positioned so that a majority of inverter cabinet 198 is in first region 188. In other embodiments, inverter cabinet 198 may be positioned so that a majority of inverter cabinet 198 is in second region 190. As illustrated, inverter cabinet 198 may be positioned within a rear portion of deck 122. The positioning of inverter cabinet 198 in this manner may provide an open area for positioning of additional mining truck components, for example.

Mining truck 100 may further include a thermal management system 200. Thermal management system 200 may include a radiator 202 and a DC/DC-battery thermal manager 204. In some embodiments, radiator 202 and DC/DC-battery thermal manager 204 may be integrated, i.e., one thermal management component may serve as both radiator 202 and DC/DC-battery thermal manager 204. In other embodiments, radiator 202 may service both engine 142 and DC/DC system 196, while battery thermal manager 204 only services battery pack module 176, described further herein. In yet other embodiments, radiator 202 may service engine 142, battery thermal manager 204 may service battery pack module 176, and a third thermal manager or heat exchanger (not shown) may service DC/DC system 196.

As illustrated, radiator 202 may be mounted to a front of mining truck 100, or, in other words, at a full forward position relative to deck 122. For example, radiator may be mounted at the first end portion 102 adjacent the first end of chassis 102. In some embodiments, radiator 202 may be, at least in part, mounted to a forward edge of deck 122 so that radiator 202 extends downward from deck 122. In other embodiments, radiator 202 may be mounted to a front of mining truck 100 below deck 122. In yet other embodiments, radiator 202 may be mounted at another position of mining truck 100.

DC/DC-battery thermal manager 204 may be positioned on deck 122 within first region 188 at a forward position of resistor grid 194 and/or DC/DC system 196. DC/DC-battery thermal manager 204 may be configured to be fluidly coupled to battery pack module 176 as described further herein, to provide coolant or refrigerated liquid to battery pack module 176, and, in some embodiments, be fluidly coupled to DC/DC system 196 to provide thermal management services to DC/DC system 196.

The arrangement of components on the deck as described herein are exemplary in nature and may be altered within the scope of the disclosure. For example, in some embodiments, first region 188 and second region 190 may be mirrored or switched. In other embodiments, components may be moved relative to one another and/or relative to deck 122. Positioning of the components of the deck as described herein may mitigate damage and/or poor performance from dust, dirt, mud, and/or other environmental considerations. However, other placements are within the scope of the disclosure.

Referring again to FIG. 1, first wheel 146 and second wheel 148 may define a space, or first side saddle 166 therebetween. In some embodiments, as illustrated, a fuel tank 168 may be mounted to chassis 102 within first side saddle 166. Fuel tank 168 may contain, for example, diesel fuel or an alternative fuel, e.g., ammonia, methanol, ethanol, or other fuels suitable for operation of mining truck 100. Likewise, third wheel 150 and fourth wheel 152 may define a space, or second side saddle 170. A first wheel motor 172 may be associated with second wheel 148 and, in embodiments including a fifth wheel, fifth wheel 154. A second wheel motor 174 may be associated with fourth wheel 152 and, in embodiments including a sixth wheel, sixth wheel 156. In some embodiments including a fifth and/or sixth wheel, each of second wheel 148, fourth wheel 152, fifth wheel 154, and sixth wheel 156 may have a separate wheel motor. In other embodiments, all of wheels 146, 148, 150, 152, 154, and 156 or wheels 146, 148, 150, 152 or any combination thereof, may be associated with a wheel motor, whether such wheel motor is designated to a single wheel or such wheel motor is shared between two or more wheels.

Mining truck 100 may include a battery pack module 176 as illustrated in FIG. 2. For example, as discussed further above, mining truck 100 may include first wheel 146 mounted at a forward position in forward region 118 on first side 132 of chassis 102, i.e., adjacent to first frame member 104 and second wheel 148 mounted at a rearward position in rear region 112 on first side 132 of chassis 102, i.e., adjacent to first frame member 104. First wheel 146 and second wheel 148 may be spaced apart to define first side saddle 166 therebetween. As illustrated, battery pack module 176 may be mounted to first side 132 of chassis 102 within first side saddle 166. In other embodiments, battery pack module 176 may be mounted to chassis 102 or another component of mining truck 100.

Battery pack module 176 may be configured to store power for use in operation of mining truck 100. In hybrid applications, battery pack module 176 may cooperate with engine 142 to provide power to wheels 146, 148, 150, 152 and, in some embodiments, wheels 154, 156 for movement of mining truck 100. Battery pack module 176 may be mounted within first side saddle 166 at a position which mitigates potential contact of any one of wheels 146, 148, 150, 152, 154 (when present) and/or 156 (when present).

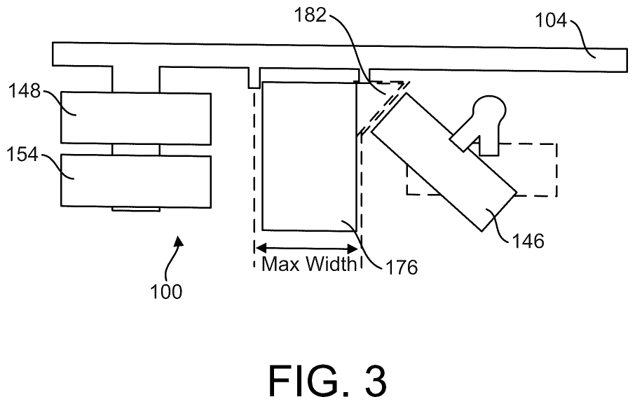

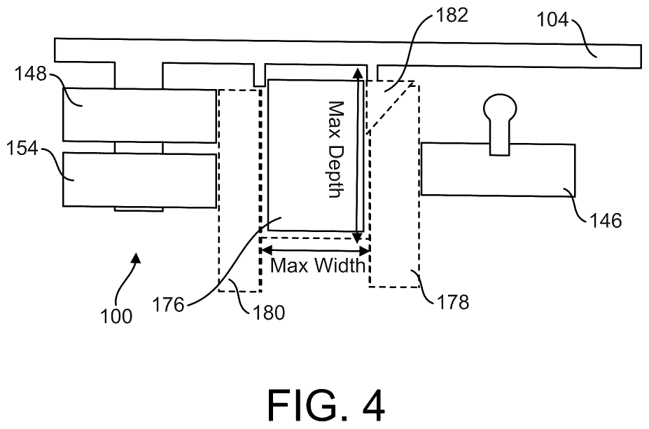

As shown in FIGS. 3-4, for example, battery pack module 176 may be mounted to chassis 102 in a manner that defines a forward access zone 178 defined between first wheel 146 and battery pack module 176 and a rearward access zone 180 defined between battery pack module 176 and second wheel 148. Forward access zone 178 and rearward access zone 180 provides clearance for movement of the wheels during operation of the mining truck, and also provides clearance for an operator, mechanic, or another person to stand within the appropriate access zone 178, 180 for access to battery pack module 176 for maintenance or other required or desired tasks.

A steering zone, or additional access zone 182, may be defined adjacent to a forward inner pocket to ensure additional clearance for the steering of first wheel 146 during operation of mining truck 100 as shown in FIG. 4. Additional access zone 182 may also provide additional clearance for the operator, mechanic, or another person to access battery pack module 176 for maintenance or other required or desired tasks. For example, in some embodiments, battery pack module 176 may be mounted to mining truck 100 (e.g., via chassis 102) in a manner so that an access to battery pack module 176 is generally positioned in or adjacent to additional access zone 182.

Referring again to FIG. 2, a hydraulic liquid tank 184 may be mounted to second side 136 of chassis 102 within second side saddle 170. Hydraulic liquid tank 184 may serve as a reservoir for containing excess hydraulic fluid for operation of mining truck 100. A second liquid tank 186 may be mounted to chassis 102 within second side saddle 170. In some embodiments, second liquid tank 186 may be a fuel tank.

As illustrated, hydraulic liquid tank 184 may be mounted to chassis 102 at an interior position of second side saddle 170, while second liquid tank 186 may be mounted to chassis 102 at an exterior position of second side saddle 170, so that hydraulic liquid tank 184 is substantially in-between chassis 102 and the second liquid tank 186. In other embodiments, hydraulic liquid tank 184 and second liquid tank 186 may be alternately arranged. For example, in some embodiments, second liquid tank 186 may be mounted to chassis 102 at an interior position of second side saddle 170, while hydraulic liquid tank 184 may be mounted to chassis 102 at an exterior position of second side saddle 170 In yet other embodiments, hydraulic liquid tank 184 and second liquid tank 186 may both be arranged at a generally interior position of second side saddle 170 so that one of hydraulic liquid tank 184 and second liquid tank 186 is positioned at a forward position near third wheel 150, and the other of hydraulic liquid tank 184 and second liquid tank 186 is positioned at a rearward position near fourth wheel 152.

In some embodiments, a third liquid tank, for example, a second fuel tank, may be mounted to the chassis 102 within second side saddle 170. In other embodiments, the second fuel tank may be mounted to chassis 102 within first side saddle 166 in tandem with battery pack module 176.

Although the embodiments described above include mounting of battery pack module 176 within first side saddle 166 with hydraulic liquid tank 184 and second liquid tank 186 mounted within second side saddle 170, other arrangements may be considered that also enjoy at least some of the advantages discussed above. For example, in some embodiments, battery pack module 176 may be mounted within second side saddle 170 adjacent to hydraulic liquid tank 184 while second liquid tank 186 is mounted to chassis 102 within first side saddle 166. In other embodiments, hydraulic liquid tank 184 may remain in second side saddle 170, second liquid tank 186 may be mounted to chassis 102 within first side saddle 166, and battery pack module 176 may be mounted to deck 122.

Mounting of battery pack module 176 within first side saddle 166 may facilitate an even balance of mining truck 100 when one or more tanks are also mounted to chassis 102 within second side saddle 170 defined between third wheel 150 and fourth wheel 152. This placement may also maximize space for battery positioning while allowing the batteries to be put in a single, unified space rather than distributed in several places over the architecture of mining truck 100. For example, in some embodiments and as described further herein, battery pack module 176 may include a plurality of battery pack layers in a vertical arrangement, where each battery pack layer of the plurality of battery pack layers includes one or more battery packs. This vertical arrangement of battery packs as positioned in a side saddle may take advantage of a height of mining truck 100 to include as many battery packs as necessary for efficient operation of mining truck 100 in a hybrid operation mode. While these benefits are acknowledged, it is also within the scope of this disclosure that battery pack module 176 and/or a plurality of battery packs may be alternately positioned, whether in a single, unified space (i.e., on deck 122, within rear region space 158, or another placement), or in a plurality of places throughout architecture of mining truck 100.

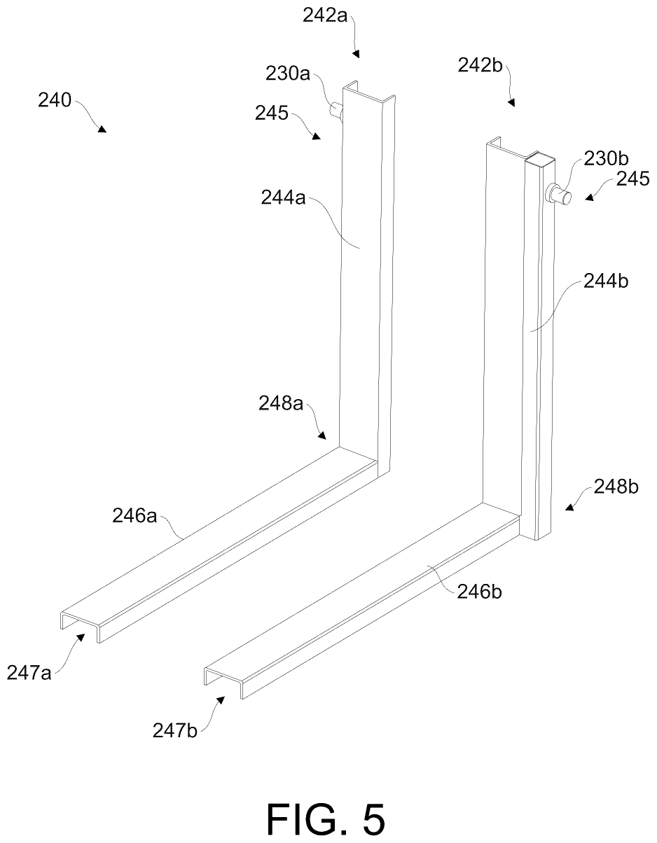

Referring to FIGS. 5-7B, a battery pack module 176 of the present disclosure is illustrated. Battery pack module 176 may include a unibody design. As used herein, a “unibody” describes a module in which individual components of the module come together to form the whole module, in this case, the battery pack module 176. In some embodiments, for example, the individual components making up the unibody of the battery pack module may be separate components which are assembled to form the unibody design. As these components are fit together, battery pack module 176 is further strengthened by the addition of more components. The unibody design allows for battery pack module to be lighter and cheaper to make than traditional battery modules. Battery pack module 176 may not include a frame but rather may be made of each of the following components coupled together. However, in an alternative embodiment, battery pack module 176 may include a frame.

Referring initially to FIG. 5, a support structure 240 of battery pack module 176 may include a first support beam 242a and a second support beam 242b. In one embodiment, support beams 242a, 242b may be shaped to accommodate forklift forks to facilitate mounting of battery pack module 176 to mining truck 100. For example, support beams 242a, 242b may be spaced apart a distance consistent with the spacing of forks of a forklift. In other embodiments, other lifting mechanisms consistent with the shape and size of support beams 242a, 242b may be used to facilitate mounting of battery pack module 176 to mining truck 100. In some embodiments, the shape and size of support beams 242a, 242b may be altered to accommodate alternative lifting mechanisms as known in the art. In yet other embodiments, support beams 242a, 242b may be generally shaped to accommodate a plurality of lifting mechanisms and/or lifting mechanisms which do not require a specific shape and/or size may be used to facilitate mounting of battery pack module 176 to mining truck 100. In yet other embodiments, battery pack module 176 may be manually mounted to mining truck 100 so that no lifting mechanisms are necessary and/or support beams 242a, 242b do not require a specific shape.

Support beams 242a, 242b may each include a vertical portion 244a, 244b and a horizontal portion 246a, 246b. The horizontal portions 246a, 246b may each include an opening 247 sized and shaped for receiving forklift forks or another lifting component of another lifting mechanism. For example, openings 247 may form pockets within horizontal portions 246a, 246b, and/or may be open toward the bottom of horizontal portions 246a, 246b to facilitate reception of forklift forks or other lifting tools. Support beams 242a, 242b may be “L” shaped, or any other shape, such as a “C” shape, that suitably accommodates a lifting device to mount battery pack module 176 within side saddle 166 of mining truck 100. As described above, in some embodiments, support beams 242a, 242b may be otherwise sized and/or shaped to facilitate cooperation with other lifting mechanisms or, in other embodiments, have a general size and shape which is generic to a plurality of lifting mechanisms or non-specific to any lifting mechanisms. As such, in some embodiments, horizontal portions 246a, 246b may not include any openings or pockets.

A distal end of vertical portion 244a may meet a distal end of horizontal portion 246a such that a coupling point 248a is formed. Similarly, a distal end of vertical portion 244b may meet a distal end of horizontal portion 246b such that a coupling point 248b is formed. Each vertical portion 244a, 244b may be coupled to its respective horizontal portion 246a, 246b using any coupling mechanisms known in the art. For example, each vertical portion 244a, 244b may be coupled to its respective horizontal portion 246a, 246b via welding, adhesive, mechanical fasteners, interference fit, locking mechanisms, bonding mechanisms, or any other coupling mechanism which facilitates operation and use of battery pack module 176 as described herein. In some embodiments, each vertical portion 244a, 244b may be formed as a single piece with its corresponding horizontal portion 246a, 246b via, for example, additive printing, casting, molding, or other manufacturing methods known in the art. In yet other embodiments, support structure 240 may include only horizontal portions 246a, 246b of first and second support beams 242a, 242b.

While support structure 240 is described above as including two support beams 242a, 242b, in some embodiments, support structure 240 may include fewer support beams (i.e., one or none) or a greater number of support beams. In some embodiments, the included number of support beams may be positioned in a variety of arrangements consistent with the environment and use of battery pack module 176 as discussed herein. For example, in some embodiments, support structure 240 may include four support beams similar to support beams 242a, 242b as discussed above, where the support beams are arranged so that two vertical beams extend between two horizontal beams to create two square or rectangular shape structures, e.g., so that the combination of all four support beams create a prism or cuboid shape, which may or may not include cross beams between the two square or rectangular shape structures. Other embodiments may include alternatively arranged support beams.

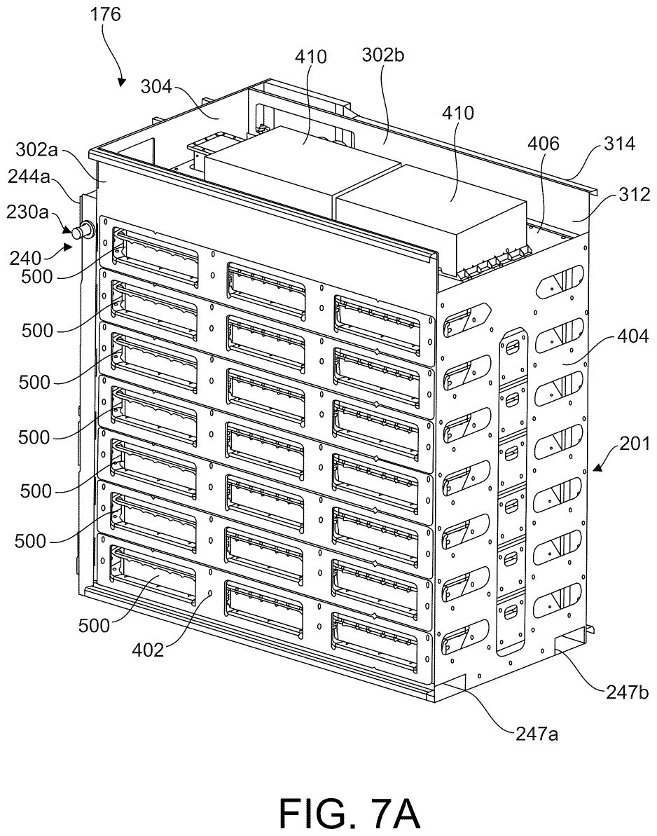

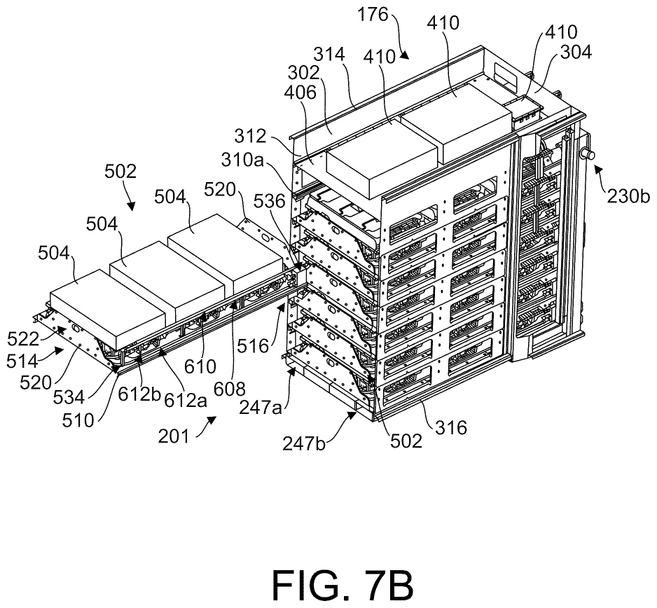

Battery pack module 176 may be removably coupled to mining truck 100 via at least one top mount and a lower mount (not shown). The top mount may include a mounting mechanism coupled to battery pack module 176; for example, the top mount may be positioned on a back panel 208 (FIG. 7B) or on support beams 242a, 242b as discussed further herein. In some embodiments, the top mount may include a mounting mechanism coupled to chassis 102 of mining truck 100. In such embodiments including the top mount being coupled to chassis 102 of mining truck 100, battery pack module 176 may include a top mount brace configured to removably couple to the at least one top mount. The top mount may be fixedly coupled and/or integrated with underlying battery pack module 176, chassis 102, or other mining truck component to facilitate structural integrity for mounting of battery pack module 176. In other embodiments, the top mount may be otherwise removably coupled to underlying battery pack module 176, chassis 102, or other mining truck component.

In some embodiments, battery pack module 176 may include two top mounts to couple battery pack module 176 to chassis 102. For example, the two top mounts might include a first chassis mounting pin 230a fixed on a top portion/proximal end 245a of vertical portion 244a of first support beam 242a and a second chassis mounting pin 230b fixed on a top portion/proximal end 245b of vertical portion 244b of second support beam 242b. Each of chassis mounting pins 230a and 230b may extend outward from its respective support beam 242a, 242b, i.e. in a direction away from the other support beam. In some embodiments, for example, chassis mounting pins 230a,230b may extend in opposite directions. In some embodiments, chassis mounting pins 230a, 230b may each extend in a generally perpendicular direction relative to its respective support beams 242a, 242b.

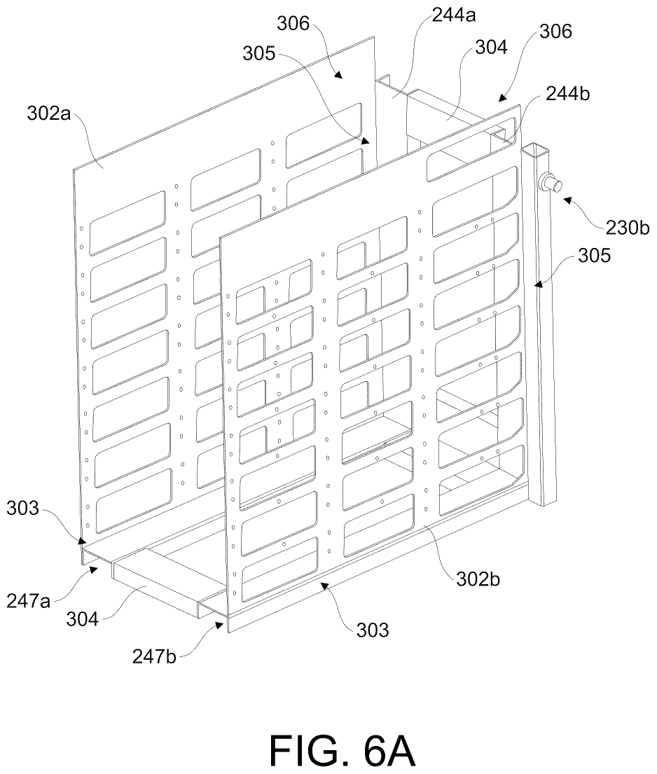

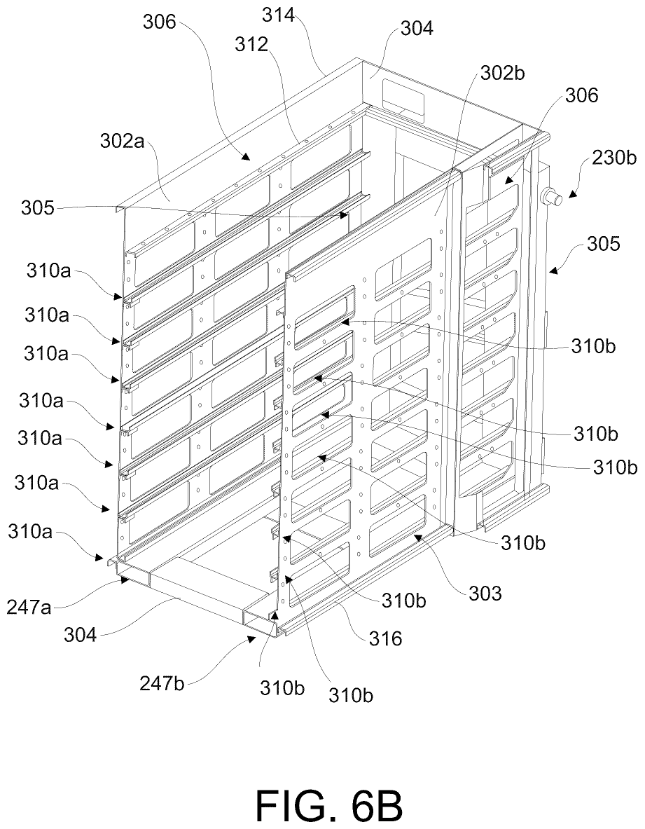

Chassis mounting pins 230a, 230b may each be configured to be received by one or more pin receiving mounts (not shown) on chassis 102 or another component of mining truck 100. Alternatively, chassis mounting pins 230a, 230b may be coupled to a top portion of side plates 302a, 302b (FIGS. 6A-6B), discussed further below.

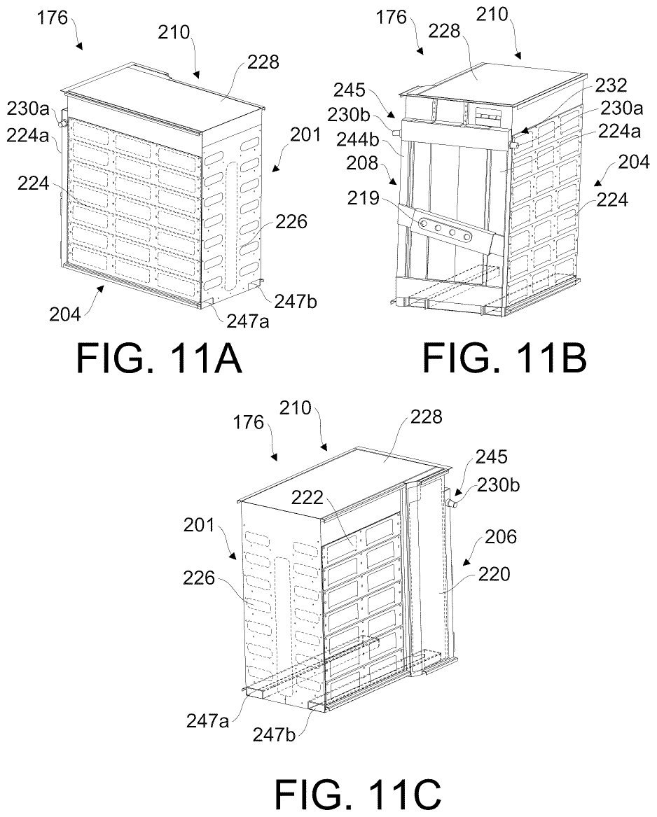

Referring briefly to FIG. 11B, battery pack module 176 may include a mounting brace 219 positioned on a back panel 208, or another panel of battery pack module 176 as described further herein, which is configured to couple to the lower mount of mining truck 100 as discussed above. The lower mount (not shown) may couple to, be integrated with, and/or extend from chassis 102 of mining truck 100 and removably couple to mounting brace 219. In some embodiments, the lower mount may include or couple to a vibration mitigation element such as a rubber disc, a spring, a torsion bar, an air bag dampener, or another vibration mitigation element. The lower mount may removably couple to mounting brace 219 such that vibration transferred from the mining truck into battery module 176 is reduced. Mounting brace 219 and/or the lower mount may be included in addition to or in alternative to the top mount (e.g., chassis mounting pins 230a, 230b) in various embodiments.

Referring now to FIGS. 6A and 6B, battery pack module 176 may include a first side plate 302a and a second side plate 302b coupled to support structure 240. For example, a bottom portion 303 of each side plate 302a, 302b may attach to a length of one of horizontal portions 246a, 246b of corresponding support beam 242a, 242b, e.g., side plate 302a corresponds with support beam 242a and side plate 302b corresponds with support beam 242b. A side portion 305 of each side plate 302a, 302b may attach to a length of one of vertical portions 244a, 244b of corresponding support beam 242a, 242b. In some embodiments, side plates 302a, 302b may be formed of sheet metal. In some embodiments, for example, side plates 302a, 302b may be formed of aluminum, brass, copper, steel, tin, nickel, titanium, silver, gold, platinum, or other metals suitable for the environment surrounding mining truck 100 and/or use of battery pack module 176. In other embodiments, side plates 302a, 302b may be formed of a polymer or other suitable material, as discussed further herein.

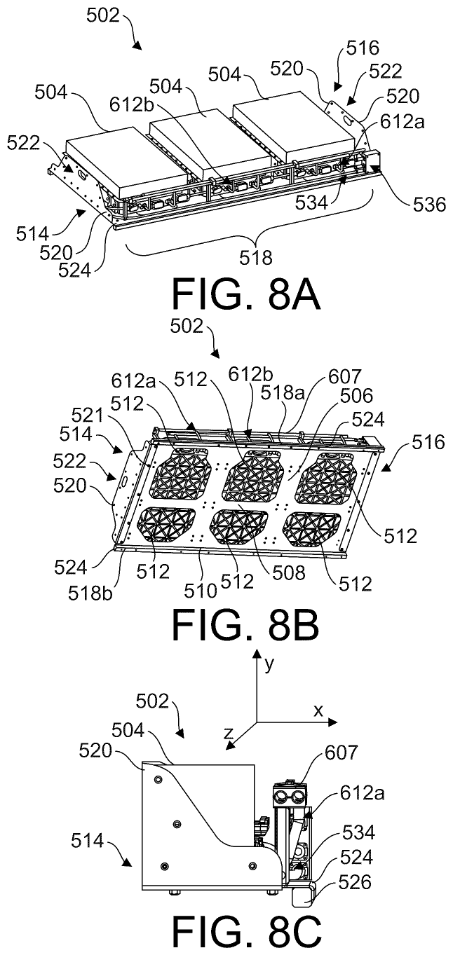

Each side plate 302a, 302b includes a plurality of support rails 310 that extend along a length of respective side plate 302a, 302b. For example, support rails 310 may extend horizontally and, in some embodiments, generally parallel to horizontal portions 246a, 246b of first and second support beams 242a, 242b. Support rails 310a of side plate 302a and support rails 310b of side plate 302b are at a similar height so that support rails 310a and support rails 310b may cooperate to form a layered pairs of support rails 310, one pair at every layer height to define a plurality of battery pack layers 500 (FIGS. 8A, 8B) as discussed further herein.

Each pair of support rails 310 are configured to receive a battery tray as discussed further below. For example, each of support rails 310a, 310b may define a sliding surface such that each battery tray slides onto a corresponding pair of support rails to be received within battery pack module 176. Support rails 310 may be U-channel rails, L-bracket rails, or other rails that provide a sliding surface for receiving a battery tray as described further herein.

Battery pack module 176 may include support plates 304 to brace battery pack module 176 and facilitate structural integrity of battery pack module 176 by providing further support. For example, as illustrated, support plates 304 may include beams that extend between vertical portions 244a, 244b and/or horizontal portions 246a, 246b of the first and second support beams 242a, 242b.

Still referring to FIGS. 6A-6B, side plates 302a, 302b and/or support plates 304 may include an upper mounting surface 312 configured to receive a stiffening tray 406 (FIGS. 8A and 8B) to reinforce and reduce bending of side panels 302a, 302b. Upper mounting surface 312 may extend a perimeter length at a top portion 306 of side plates 302a, 302b and/or support plate 304 between vertical portions 244a, 244b of the first and second support beams. Upper mounting surface 312 may be comprised of a support rail similar to support rails 310 or another rail or support surface coupled to an upper portion of side plates 302a, 302b and/or support plates 304. In other embodiments, upper mounting surface 312 may be integrally formed with side plates 302a, 302b and/or support plate 304.

Side plates 302a, 302b and support plate(s) 304 may further include a top cover mounting surface 314 configured to allow for the coupling of a fifth service access panel/top cover 228 (FIGS. 11A-11C). Top cover mounting surface 314 may extend an outer perimeter length of side plates 302a, 302b and/or a support plate 304 between vertical portions 244a, 244b of the first and second support beams 242a, 242b above upper mounting surface 312. Top cover mounting surface 314 may be a rail similar to support rails 310 or another rail coupled to a top portion of side plates 302a, 302b and/or support plate(s) 304. In other embodiments, top cover mounting surface 314 may be an integral extension of side plates 302a, 302b and/or support plate(s) 304. In yet other embodiments, top cover mounting surface 314 may be any flat surface of side plates 302a, 302b and/or support plate(s) 304 corresponding with the top portion of side plates 302a, 302b and/or support plate(s) 304. In some embodiments, the structure of top cover mounting surface 314 may vary between side plates 302a, 302b and/or support plate(s) 304.

Side plates 302a, 302b and/or support plate 304 may include a bottom mounting surface 316 along a lower perimeter of side plates 302a, 302b and/or support plate 304 between vertical portions 244a, 244b of the first and second support beams. Mud flaps, water guards, mounting guards, fluid seals and other protective components may be coupled to bottom mounting surface 316 and upper mounting surface 312 to protect battery pack module 176 from outside elements and fluids. For example, mounting guards, mud flaps, mounting guards, etc. may be coupled to upper mounting surface 312 and bottom mounting surface 316 in such a manner that the sides of battery pack module 176, e.g., side panels 302a, 302b, support plate 304, and/or end locking plate 404 discussed further below, are substantially or fully covered by the protective components. In some embodiments, the protective components may also couple to battery pack module at one or more coupling points between upper mounting surface 312 and bottom mounting surface 316.

FIGS. 7A and 7B illustrate the interior of battery pack module 176 and its components. For example, battery pack module 176 includes at least one battery pack layer 500 and may include a plurality of battery pack layers 500. In some embodiments, as illustrated, battery pack module 176 includes seven battery pack layers 500. In other embodiments, battery pack module 176 may include a greater or fewer number of battery pack layers 500, including 1, 2, 3, 4, 5, 6, 8, 9, 10, 11, 12, 13, 14, 15, or a greater amount of battery pack layers 500 as suitable for the application of battery pack module 176 and/or the space available for mounting battery pack module 176.

Each battery pack layer 500 may include at least one battery tray 502 with one or more battery packs 504 positioned on battery tray 502. For example, one or more battery packs 504 may be removably coupled to each battery tray 502. Battery trays 502 may be shaped and sized to have a width only slightly narrower than a width between side plates 302a, 302b.

Battery trays 502 may be configured to slide onto support rails 310, i.e., a sliding surface of a corresponding support rail 310, such that battery trays 502 are positioned in a vertical arrangement, consistent with the arrangement of battery pack layers 500. Each battery tray 502 may be capable of removal from battery module 176 independently from the other battery trays 502. For example, each battery tray 502 may be independently slideable along corresponding sliding surface of corresponding support rails 310. In some embodiments, battery trays 502 may be removable by sliding out of battery module 176 in a direction away from chassis 102 of mining truck 100 (FIG. 1). Removal of battery trays 502 may facilitate access to battery packs 504 for servicing, replacement, or other purposes.

To maintain a position of each battery tray 502 within its corresponding battery pack layer 500, each battery pack layer 500 may include two side locking plates 402. For example, each battery pack layer 500 may include one side locking plate positioned on either side of battery pack layer 500 so that each side locking plate 402 is coupled to one of side plates 302a, 302b (shown in FIG. 7A relative to 302a, however, it is understood that the arrangement of a side locking plate with side plate 302b is the same or similar).

Side locking plates 402 may maintain, or lock, the battery tray 502 within corresponding battery pack layer 500 to mitigate or prevent movement of battery tray 502 during operation of mining truck 100 and/or other unintentional movement.

Each battery tray 502 may be further maintained within corresponding battery pack layer 500 by an end locking plate 404. End locking plate 404 may extend between and/or removably couple to first side plate 302a and second side plate 302b. End locking plate 404 may extend vertically so that end locking plate 404 at least partially covers each battery pack layer 500 and, thereby, each battery tray 502 to mitigate or prevent unintentional sliding of battery pack layer battery trays 502 out of battery pack module 176. In some embodiments, end locking plate 404 may additionally or alternatively removably couple to an end 514 of at least one of battery trays 502 opposite of support structure 240. In some embodiments, end locking plate 404 may removably couple to a plurality of battery trays 502 or all of battery trays 502.

While side locking plate(s) 402 and end locking plate(s) 404 may be utilized to hold or lock battery tray 502 in position relative to battery pack layer 500, other embodiments may include other or alternative locking mechanisms to hold battery tray 502 in position relative to battery pack layer 500. For example, in some embodiments, battery tray 502 may be bolted to battery pack layer 500 to hold battery tray 502 in position while maintaining the removable feature of battery tray 502. In other embodiments, other locking mechanisms may be considered, including tab-in-groove, clips, removable adhesive, magnets, or other locking mechanisms known in the art. Such locking mechanisms may be used in conjunction with or alternatively to side end plate(s) 402 and end locking plate(s) 404.

FIGS. 8A-8C further illustrate battery tray 502. Each battery tray 502 may be substantially similar to the other battery trays 502 of battery pack module 176. As such, while a singular battery tray is discussed below, the features and characteristics discussed herein generally apply to every battery tray 502 of battery pack module 176.

Battery tray 502 may include a tray surface 506 and an outer frame 510 that surrounds an outer perimeter of tray surface 506. The outer perimeter of tray surface 506 may include a first side 518a, a first end 514, a second side 518b, and a second end 516, wherein first side 518a and second side 518b may each have a length 518, and first end 514 and second end 516 are spaced apart by length 518.

An end plate 520 may be coupled to each of first end 514 and second end 516. End plate 520 may be coupled such that a mounting lip 521 extends from end plate 520 on first end 514 and/or second end 516 onto an underside of tray surface 506, such as onto battery support joists 508 as discussed further herein. Mounting lip 521 may provide stability and structure to the tray during lifting, installation, and removal from battery pack module 176.

End plates 520 may also include a tray lifting feature 522 configured to allow battery tray 502 to be grasped and slid out of corresponding battery pack layer 500 on support rails 310. In one embodiment, tray lifting feature 522 may be a hole configured to receive a tool or a finger, for example, to facilitate application of force to the battery tray 502 for removal of battery tray 502 from battery pack layer 500. End plates 520 and/or mounting lip 521 may be manufactured separately and later coupled to battery tray 502 in some embodiments. In other embodiments, end plates 520 and/or mounting lip 521 may be integrally formed with battery tray 502.

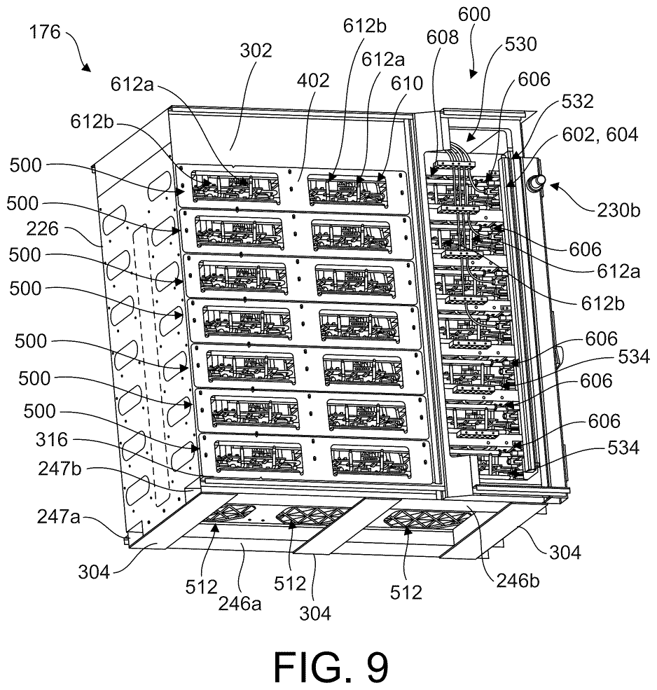

Referring now to FIG. 9B, tray surface 506 may include a plurality of battery support joists 508. Each of battery support joists 508 may extend between first side 518a and second side 518b and/or between first end 514 and second end 516 of outer frame 510 such that tray openings 512 are defined therebetween. Battery support joists 508 are configured to support one or more battery packs 504 on tray surface 506. For example, in some embodiments, each battery pack 504 may be removably coupled to one or more battery support joists 508. In one embodiment, battery support joists 508 may form a lattice structure.

Tray openings 512 allow for drainage of fluid through of each battery tray 502. For example, tray openings 512 may allow flow of liquid fluid from a battery pack layer 500 toward the bottom mounting surface 316 of battery pack module 176. Additionally, tray openings 512 allow for air to circulate through the plurality of battery pack layers 500, facilitating temperature control of battery packs 504 by cooling the battery packs 504 on each battery tray 502.

Each battery tray 502 may support a plurality of battery packs 504. For example, each battery tray 502 may have a plurality of battery packs 504 removably coupled thereto, i.e., to tray surface 506 and/or battery support joists 508. In one embodiment, each battery tray 502 may include three battery packs 504. In other embodiments, a greater or fewer number of battery packs 504 may be included, such as 1, 2, 4, 5, 6, 7, 8, 9, 10, or greater battery packs as battery tray 502 is capable of supporting.

Now referring to FIG. 9C, a stiffening ridge 524 may extend along at least a portion of each of first side 518a and second side 518b of battery tray 502. Stiffening ridge 524 is configured to strengthen battery tray 502 to mitigate or prevent flexing of the tray along the x, y, and/or z axes during installation, use of corresponding vehicle, or removal of battery tray 502. In some embodiments, stiffening ridge 524 of each of first side 518a and second side 518b may extend the entirety of length 518. In other embodiments, stiffening ridge 524 of one of first side 518a and second side 518b may only extend a portion of length 518 while stiffening ridge of the other of first side 518a and second side 518b may extend the entirety of length 518. In yet other embodiments, stiffening ridge 524 of each of first side 518a and second side 518b may only extend a portion of length 518. In some embodiments, only one side of first side 518a and second side 518b may include stiffening ridge 524. Stiffening ridge 524 may be “U” shaped, “L” shaped, or any other suitable shape that mitigates or prevents flexing of battery tray 502. Each stiffening ridge 524 may include a sliding surface 526 configured to cooperate with support rails 310 on each of side plates 302a, 302b to slide battery tray 502 into battery pack module 176. Sliding surface 526 may be a flat bottom surface, an L-bracket, a U-channel, or a sliding rail, such as a nylon sliding rail.

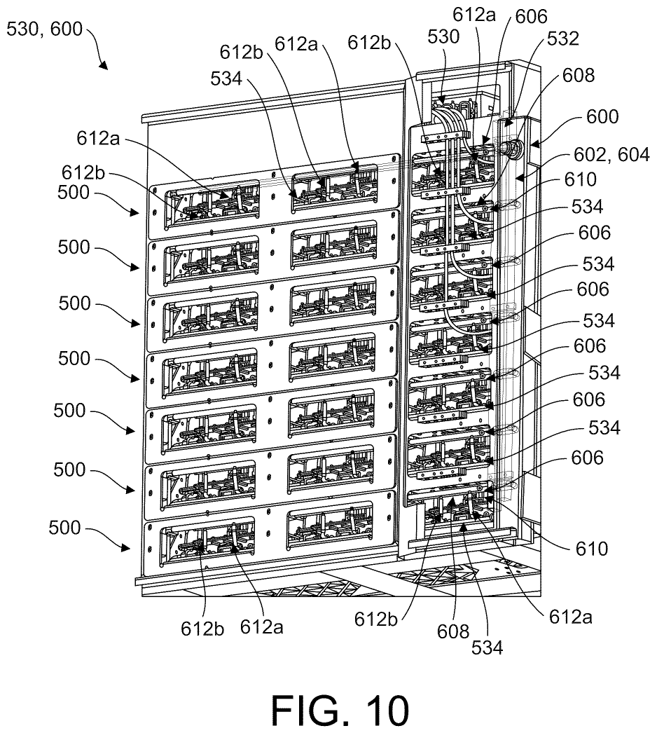

Referring additionally to FIGS. 9 and 10, battery pack module 176 may include cabling 530 for electronically coupling battery packs 504 together and/or to mining truck 100. Cabling 530 may include a primary cabling line 532 and a plurality of layer cabling lines 534—one layer cabling line 534 for each battery pack layer 500. In some embodiments, each battery pack 504 of a corresponding battery pack layer 500 may be electronically coupled to layer cabling line 534 in parallel such that one battery pack 504 of the plurality of battery packs 504 may be removed without disrupting current flow from the remaining battery packs. In other embodiments, each battery pack 504 of a corresponding battery pack layer 500 may be electronically coupled to layer cabling line 534 in series.

Current flowing from the connected battery packs may be supplied to corresponding layer cabling line 534 and flow via layer cabling line 534 to a corresponding high voltage electrical interface box 536 at the second end 516 of battery tray 502. Corresponding high voltage electrical interface box 536 may transmit the current from layer cabling line 534 to the primary cabling line 532. Each corresponding layer cabling line 534 may run the entire length of corresponding battery tray 502 of its corresponding battery pack layer 500. In other embodiments, each corresponding layer cabling line 534 may run a portion of the length of corresponding battery tray 502 of its corresponding battery pack layer 500 but defines a length which facilitates coupling of each battery pack 504. Primary cabling line 532 may run vertically along at least a portion of a height of battery pack module 176 to facilitate coupling of each high voltage electrical interface box 536 as discussed further herein.

Primary cabling line 532 may be coupled to main battery high voltage connection boxes/low voltage system 410 located on upper mounting surface 312 (shown in FIGS. 7A-7B). In other words, the current from battery packs 504 may flow through corresponding layer cabling line 534, through high voltage electrical interface box 536, into primary cabling line 532, and to main battery high voltage connection box/low voltage system 410 to supply the mining truck with power. Primary cabling line 532 may couple to each high voltage electrical interface box 536 of each battery pack layer 500 in parallel or in series. During service of battery pack module 176, an operator may disconnect a layer cabling line 534 from its corresponding high voltage electrical interface box 536 to ensure no current is flowing through the corresponding battery packs 504 of a corresponding battery tray 502.

Still referring to FIGS. 9 and 10, battery pack module 176 may include a cooling system including cooling lines 600. Cooling lines 600 may include a primary coolant supply line 602, a primary coolant return line 604, and a battery pack layer coolant line 606 at each battery pack layer 500. Primary coolant supply line 602 may be fluidly coupled to a source of coolant fluid and supply coolant to the components of battery pack module 176 as described further herein.

For example, coolant may flow into primary supply line 602 and then into each battery pack layer 500 via battery pack layer coolant lines 606 at second end 516 of battery tray 502. Each battery pack layer 500 may be supplied with coolant by a corresponding battery pack layer coolant line 606. Battery pack layer coolant lines 606 may branch from primary supply line 602 such that battery pack layer coolant lines 606 are connected in parallel. In other embodiments, battery pack layer coolant lines 606 may be fluidly coupled to primary supply line 602 in series. Each battery pack layer coolant line 606 may be substantially similar to each other.

Battery pack layer coolant lines 606 may extend across second side 518b of corresponding battery tray 502. Battery pack layer coolant lines 606 may be supported by a layer cooling line mounting bracket 607 (FIGS. 8A-8C) of corresponding battery tray 502. In other embodiments, battery pack layer coolant lines 606 may extend across first side 518a. In yet other embodiments, layer cooling line mounting bracket 607 may be coupled to first side plate 302a or second side plate 302b at the level of corresponding battery pack layer 500. Other mechanisms and methods for supporting battery pack layer coolant lines 606 for the purposes further described herein may be used to facilitate coupling of battery pack layer coolant lines 606 to the necessary components of battery pack module 176 for operation as described further herein.

Battery pack layer coolant lines 606 may include a layer supply cooling line 608 and a layer return cooling line 610. Each layer supply cooling line 608 branches off to each corresponding battery pack 504 of corresponding battery pack layer 500 via a plurality of layer supply branch cooling lines 612a such that each battery pack 504 is connected to layer supply line 608, i.e. each battery pack 504 may be connected to its own corresponding layer supply branch cooling line 612a. In some embodiments, layer supply cooling line 608 may couple to battery packs 504 via layer supply branch cooling lines 612a in parallel. In other embodiments, layer supply cooling line 608 may couple to battery packs 504 via layer supply branch cooling lines 612a in series. Coolant may flow from the source of coolant fluid into primary cooling line 602, each layer supply cooling line 608, and each layer supply branch cooling line 612a to each battery pack 504.

The coolant cools the battery and is returned through layer return line 610. Layer return line 610 is branched off to each corresponding battery pack 504 of corresponding battery pack layer 500 via a plurality of layer return branch cooling lines 612b such that each battery pack 504 is connected to the layer return line 610, i.e., each battery pack 504 may be connected to its own corresponding layer return branch cooling line 612b. In some embodiments, layer return line 610 may couple to battery packs 504 via layer return branch cooling lines 612b in parallel. In other embodiments, layer return line 610 may couple to battery packs 504 via layer return branch cooling lines 612b in series. Each layer return line 610 may be fluidly coupled to primary coolant return line 604 at its corresponding battery pack layer 500 such that returned fluid may flow through layer return line 610 and into primary coolant return line 604 to be sent to a heat exchanger or other cooling mechanism and recycled back to primary coolant lines 602, dumped, or otherwise removed from battery pack module 176. In some embodiments, during cold operating conditions, the returned coolant may be used to heat other components of the mining truck.

As discussed above, cooling lines 600 may be connected in parallel, in series, or in combination. In embodiments including parallel connectivity, such embodiments may experience more evenly distributed coolant distribution between battery packs 504 and/or battery pack layers 500. Such distribution may further experience a reduction in pressure loss compared to other traditional cooling systems. These features may allow for a more compact battery pack module 176.

Now referring to FIGS. 11A-11C, battery pack module 176 may include a front panel 201 corresponding with a front or first side of battery pack module 176; a back panel 208 corresponding with a back or second side of battery pack module 176; a first sidewall panel 203 extending from front panel 201 to back panel 208 and corresponding with a third side of battery pack module 176; a second sidewall panel 206 extending from front panel 201 to back panel 208 and corresponding with a fourth side of battery pack module 176; and/or a fifth side, or top panel 210. Battery pack module 176 may further include at least one service access, such as a door, portal, flap, etc., defined by or within one or more panels to allow access to the interior of battery pack module 176 as described above. For example, the service accesses as described herein may be defined by a portion of a corresponding panel (i.e., a portion of a corresponding panel may be cut out and/or covered with a flap, removable cover etc.) and/or the entirety of a corresponding panel may service as a service access.

For example, first service access 224 may be defined within or by first sidewall panel 203 of battery pack module 176 so that removal of a portion or the entirety of first sidewall panel 203 or a door, flap, etc. corresponding with first sidewall panel 203 may provide access to side plates 302a, 302b, battery trays 502 (FIGS. 8A-8B), layer cabling lines 534 (FIGS. 8A-10), and/or battery pack layer cooling lines 606 (FIGS. 8A-10) via first service access 224.

Second service access 220 may be defined within or by second sidewall panel 206. For example, second sidewall panel 206 may include a first portion 206a consistent with second service access 220, arranged so that a first edge of first portion 206a is adjacent to an edge of back panel 208 and a second edge of first portion 206a is adjacent to an edge of a second portion 206b of second sidewall panel 206. Second portion 206b of second sidewall panel 206 may be consistent with a third service access 222 discussed further herein.

Second sidewall panel 206 may be coupled to one of side plates 302a, 302b and is illustratively coupled to second side plate 302b. Removal of a portion or the entirety of first portion 206a of second sidewall panel 206 or a door, flap, etc. corresponding with first portion 206a of second sidewall panel 206 may provide access, via second service access 220, to battery cabling 530, primary cabling line 532, layer cabling lines 534, high voltage electrical interface box 536, cooling lines 600, and/or battery pack layer cooling lines 606.

Third service access 222 may, as discussed above, be defined within or by second portion 206b of second sidewall panel 206. Second portion 206b of second sidewall panel 206 may be arranged so that a first edge is adjacent to an edge of front panel 201 and a second edge is adjacent to the second edge of first portion 206a of second sidewall panel 206 as discussed above. Removal of a portion or the entirety of second portion 206b of second sidewall panel 206 may provide access, via third service access 222, to battery trays 502, layer cabling lines 534, and battery pack layer cooling lines 606.

First service access 224 and third service access 222 may be similar in that they each provide similar access to the interior of battery pack module 176 and its components and/or contents. However, in some embodiments, third service access 222 and/or second portion 206b of second sidewall panel 206 may be smaller in area than first service access 224 and/or first sidewall panel 203. In other embodiments, third service access 222 and/or second portion 206b of second sidewall panel 206 may be the same area or larger in area than first service access 224 and/or first sidewall panel 203. For example, in some embodiments, second sidewall panel 206 may include only one portion consistent with second portion 206b and third service access 222, i.e., in some embodiments, second sidewall panel 206 does not include first portion 206a or second service access 220. In such embodiments, the components described above as accessible via second service access 220 may be accessible via third service access 222.

Fourth service access 226 may be defined within or by front panel 201 of battery pack module 176. Removal of a portion or the entirety of front panel 201 or a door, flap, etc. corresponding with front panel 201 may provide access, via fourth service access 226, to end tray locking plate 404 and tray lifting feature 522 of each of battery trays 502. Fifth service access 228 may be defined within or by top panel 210 to cover connection boxes and top stiffening tray 306. Removal of a portion or the entirety of top panel 210 or a door, flap, etc. corresponding with top panel 210 may provide access, via fifth service access 228, to connection boxes and top stiffening tray 306.

While services accesses 220, 222, 224, 226, and 228 are described herein as being associated with a particular panel and in a particular arrangement providing access to particular components, it is understood that such description is meant only as an example and some embodiments may have alternative arrangement of accesses and panels within the spirit of the disclosure. For example, in some embodiments, each panel may include only one service access, while in other embodiments each panel may include a plurality of service accesses. In yet other embodiments, one or more panels may not include a service access.

In some embodiments, at least a portion of first portion 206a of second sidewall panel 206 may be removed from the second side of battery pack module 176 or otherwise moved away from the second side of battery pack module 176 to expose cabling 530 and cooling lines 600, including primary cabling line 532, layer cabling line(s) 534, high voltage electrical interface box(es) 536, primary coolant supply line 602, primary coolant return line 604, and/or battery pack layer cooling line(s) 606. Corresponding layer cabling line 534 of a selected battery tray layer 500 may be uncoupled from corresponding high voltage electrical interface box 536 to interrupt current flow from all of battery packs 504 corresponding with the battery pack layer 500 being serviced.

A portion of or entirety of front panel 201 may be removed from the front side of battery pack module 176 or otherwise moved away from the front side of battery pack module 176 to expose end locking plate(s) 404. Corresponding end locking plate 404 of the battery tray 502 of the selected battery pack layer 500 may be uncoupled from battery pack module 176 to expose end plates 520 of corresponding battery tray 502. A tool or other removal device may be inserted into tray lifting feature 522 of corresponding battery tray 502 to slide battery tray 502 at least partially out of battery pack module 176 along the sliding surface(s) of corresponding support rail(s) 310 of corresponding battery pack layer 500. Individual battery pack(s) 504 of selected battery tray 502 may then be disconnected at the pack level and/or otherwise serviced.

Once servicing is complete, battery tray 502 may be slid back into battery pack module 176 along the sliding surface(s) of corresponding support rail(s) 310 of corresponding battery pack layer 500. Layer cabling line 534 may then be reconnected to corresponding high voltage electrical interface box 536. Corresponding end tray locking plate 404 may be recoupled to battery pack module 176, and the portion or entirety of front panel 201 and/or first portion 206a of second sidewall panel 206 may be placed back into position and coupled to battery pack module 176 where appropriate.

In some embodiments, a portion of or entirety of first sidewall panel 203, second portion 206b of second sidewall panel 206, and/or top panel 210 may be removed from battery pack module 176 or otherwise moved away from the corresponding portion of battery pack module 176 to service components of battery pack module 176, i.e., via the corresponding access as discussed above. For example, main battery high voltage connection boxes/low voltage system 410 may be accessed by removing a portion of or entirety of top panel 210 and/or otherwise moving a portion of or entirety of top panel 210 away from the top of battery pack module 176.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practices in the art to which this disclosure pertains.

### ASPECTS

Aspect 1 is a layered battery pack module configured for mounting on a mining truck, the layered battery pack module comprising: a support structure comprising a first support beam and a second support beam, each of the first support beam and the second support beam comprising a vertical portion and a horizontal portion, a distal end of the vertical portion coupled to a distal end of the horizontal portion so that the vertical portion and the horizontal portion define an angle therebetween; a first side plate coupled to the vertical portion of the first support beam and the horizontal portion of the first support beam; a second side plate coupled to the vertical portion of the second support beam and the horizontal portion of the second support beam, the second side plate being positioned opposite of the first side plate; and a plurality of battery pack layers defined between the first side plate and the second side plate.

Aspect 2 is the layered battery pack module of Aspect 1, further comprising a plurality of battery pack trays, each battery pack tray of the plurality of battery pack trays removably coupled to one corresponding battery pack layer of the plurality of battery pack layers.

Aspect 3 is the layered battery pack module of Aspect 2, wherein each battery pack tray of the plurality of battery pack trays comprises: a battery tray surface; and at least one battery pack coupled to the battery tray surface; wherein each battery pack tray of the plurality of battery pack trays is configured to slide onto a sliding surface of the one corresponding battery pack layer of the plurality of battery pack layers.

The Aspect 4 is the layered battery pack module of Aspect 3, further comprising a first end plate coupled to a distal end of the battery tray surface and a second end plate coupled to a proximal end of the battery tray surface such that the first end plate and the second end plate extend in a direction perpendicular to the battery tray surface.

Aspect 5 is the layered battery pack module of any one of Aspects 3-4, wherein the sliding surface of each battery pack layer of the plurality of battery pack layers comprises a first support rail coupled to the first side plate extending a length of the first side plate and a second support rail coupled to the second side plate opposite of and parallel to the first support rail, the second support rail extending a length of the second side plate.

Aspect 6 is the layered battery pack module of any one of Aspects 1-5, further comprising a top stiffening tray coupled to an upper portion of each of the first side plate and the second side plate.

Aspect 7 is the layered battery pack module of any one of Aspects 1-6, further comprising: a first mounting pin coupled to a proximal end of the vertical portion of the first support beam; and a second mounting pin coupled to a proximal end of the vertical portion of the second support beam.

Aspect 8 is the layered battery pack module of any one of Aspects 1-7, further comprising a back plate extending between the first side plate and the second side plate, the back plate including a mounting brace configured to couple to a lower mount of the mining truck.

Aspect 9 is a layered battery pack module configured for mounting on a mining truck, the layered battery pack module comprising: a first side plate corresponding with a first side of the layered battery pack module; a second side plate corresponding with a second side of the layered battery pack module; a plurality of battery pack layers between the first side plate and the second side plate, each battery pack layer of the plurality of battery pack layers defining a sliding surface; and a plurality of battery pack trays, each battery pack tray of the plurality of battery pack trays configured to be removably received by a corresponding battery pack layer of the plurality of battery pack layers; wherein each battery pack tray of the plurality of battery pack trays comprises: a battery tray surface; and at least one battery pack coupled to the battery tray surface.

Aspect 10 is the layered battery pack module of Aspect 9, further comprising a first end plate coupled to a distal end of the battery tray surface and a second end plate coupled to a proximal end of the battery tray surface such that the first end plate and the second end plate extend in a direction perpendicular to the battery tray surface.

Aspect 11 is the layered battery pack module of Aspect 10, wherein the first end plate and the second end plate each include a tray lifting feature.

Aspect 12 is the layered battery pack module of any one of Aspects 10-11, wherein the sliding surface of each battery pack layer of the plurality of battery pack layers is defined by: a first support rail coupled to the first side plate and extending a length of the first side plate; and a second support rail coupled to the second side plate and extending a length of the second side plate.

Aspect 13 is the layered battery pack module of Aspect 12, wherein each battery pack tray of the plurality of battery pack trays includes a first sliding rail configured to slideably couple to the first support rail and a second sliding rail configured to slideably couple to the second support rail.

Aspect 14 is the layered battery pack module of any one of Aspects 9-13, wherein each battery pack tray of the plurality of battery pack trays is configured to slide along the sliding surface of the corresponding battery pack layer in a direction away from a chassis of the mining truck.

Aspect 15 is the layered battery pack module of any one of Aspects 9-14, further including a locking mechanism to hold each battery pack tray of the plurality of battery pack trays in a position relative to the corresponding battery pack layer.

Aspect 16 is a layered battery pack module configured for mounting to a mining truck, the layered battery pack module comprising: a first support beam having a first end portion and a second end portion; a first plate coupled to the first support beam to form a first sidewall; a second plate coupled to the first support beam to form a back panel, the second plate including a mounting brace positioned nearer the second end portion of the first support beam than the first end portion of the first support beam, and the mounting brace configured to couple to a lower mount of a chassis of a vehicle; and a first pivot pin coupled to and extending from one of the first end portion of the first support beam than the second end portion of the first support beam, the first pivot pin configured to be received by a pin receiving mount of the chassis of the vehicle.

Aspect 17 is the layered battery pack module of Aspect 16, further comprising: a second support beam having a first end portion and a second end portion, the second support beam coupled to the second plate opposite the first support beam; a third plate coupled to the second support beam to form a second sidewall; and a second pivot pin coupled to and extending from one of the first end portion of the second support beam and the third plate nearer the first end portion of the second support beam than the second end portion of the second support beam, the second pivot pin configured to be received by the pin receiving mount of the chassis of the vehicle.

Aspect 18 is the layered battery pack module of any one of Aspects 16-17, wherein the first pivot pin extends in a generally perpendicular direction relative to the first support beam or the first plate.

Aspect 19 is the layered battery pack module of any one of Aspects 16-18, wherein the mounting brace is configured to removably couple to the lower mount of the chassis of the vehicle.

Aspect 20 is the layered battery pack module of any one of Aspects 16-19, wherein the lower mount to the chassis of the vehicle includes a vibration mitigation element.

Aspect 21 is the layered battery pack module of any one of Aspects 1-8, wherein the plurality of battery pack layers includes seven battery pack layers.

Aspect 22 is the layered battery pack module of Aspect 3, wherein each battery pack tray of the plurality of battery pack trays includes three battery packs.

Aspect 23 is the layered battery pack module of Aspect 5, wherein each battery pack tray of the plurality of battery pack trays is configured to slide onto the first support rail and the second support rail of the corresponding battery pack layer of the plurality of battery pack layers.

Aspect 24 is the layered battery pack module of any one of Aspects 1-8, wherein each of the first side plate and the second side plate include a bottom mounting surface on a bottom portion of the first side plate and the second side plate and an upper mounting surface on an upper portion of the first side plate and the second side plate.

Aspect 25 is the layered battery pack module of Aspect 24, wherein at least one of a mud flap, a water guard, and a fluid seal are removably coupled to at least one of the bottom mounting surface and the upper mounting surface.

Aspect 26 is the layered battery pack module of any one of Aspects 24-25, further comprising a top mounting surface coupled to a top portion of each of the first side plate, the second side plate, and a back plate extending between the first side plate and the second side plate, the top portion being above each of the upper portion of the first side plate and the second side plate and an upper portion of the back plate.

Aspect 27 is the layered battery pack module of Aspect 26, further comprising: a first service access panel coupled to the first side plate; a second service access panel and a third service access panel coupled to the second side plate; a fourth service access panel coupled to a front plate of the battery pack module; and a fifth service access panel coupled to a top plate of the battery pack module, the top plate being coupled to the top mounting surface.

Aspect 28 is the layered battery pack module of any one of Aspects 1-8, wherein the layered battery pack module has a unibody design.

Aspect 29 is the layered battery pack module of any one of Aspects 9-15, wherein each battery pack tray of the plurality of battery pack trays is configured to slide into one battery pack layer of the plurality of battery pack layers.

Aspect 30 is the layered battery pack module of any of Aspects 9-15, wherein the plurality of battery pack layers includes seven battery pack layers.

Aspect 31 is the layered battery pack module of any of Aspect 9-15, wherein the plurality of battery packs includes three battery packs.

Aspect 32 is the layered battery pack module of any of Aspects 9-15, wherein the first end plate and the second end plate are coupled to the battery tray surface such that a mounting lip of the first end plate and the second end plate extends a distance parallel to the battery tray surface.

Aspect 33 is the layered battery pack module of any of Aspects 9-15, wherein each battery pack tray of the plurality of battery pack trays includes two stiffening ridges, each stiffening ridge of the two stiffening ridges extending a length of the battery pack tray between the distal and proximal ends, wherein the two stiffening ridges are configured to reduce flexing of the battery pack.

Aspect 34 is the layered battery pack module of any of Aspects 9-15, wherein the battery tray surface comprises at least one opening configured to allow fluid to drain through the battery pack tray.

Aspect 35 is the layered battery pack module of any of Aspects 9-15, further comprising a support structure including a first support beam and a second support beam, each of the first support beam and the second support beam comprising a vertical portion and a horizontal portion, wherein a distal end of the vertical portion couples to a distal end of the horizontal portion to form an angle therebetween.

Aspect 36 is the layered battery pack module of Aspect 35, further comprising: a first mounting pin coupled to a proximal end of the vertical portion of the first support beam; and a second mounting pin coupled to a proximal end of the vertical portion of the second support beam.

Aspect 37 is the layered battery pack module of any of Aspects 9-15, further comprising: a back panel having a mounting brace; a first mounting pin coupled to the first side of the layered battery pack module; and a second mounting pin coupled to the second side of the layered battery pack module.

Aspect 38 is the layered battery pack module of Aspect 37, wherein the mounting brace is configured to couple to a lower mount of the mining truck.

Aspect 39 is the layered battery pack module of any one of Aspects 36-38, wherein the battery pack module is configured to be mounted to the mining truck via the mounting pins.

Aspect 40 is the layered battery pack module of any of Aspects 9-15, further comprising cooling lines, the cooling lines including: a primary cooling supply line, the primary cooling supply line fluidly coupled to a coolant fluid source; a primary return cooling line; and a plurality of battery pack layer cooling lines fluidly coupled to the primary supply cooling line and the primary return cooling line in parallel, each battery pack layer cooling line of the plurality of battery pack layer cooling lines corresponding to one battery pack layer of the plurality of battery pack layers.

Aspect 41 is the layered battery pack module of Aspect 40, wherein each battery pack layer cooling line of the plurality of battery pack layer cooling lines comprises: a layer supply line fluidly coupled to a plurality of layer supply branch lines in parallel, each layer supply branch line of the plurality of layer supply branch lines corresponding with one battery pack of the plurality of battery packs; and a layer return line fluidly coupled to a plurality of layer return branch lines in parallel, each layer return branch line of the plurality of layer return branch lines corresponding with one battery pack of the plurality of battery packs.

Aspect 42 is the layered battery pack module of Aspect 40, wherein each battery pack layer cooling line of the plurality of battery pack layer cooling lines comprises: a layer supply line fluidly coupled to a plurality of layer supply branch lines in series, each layer supply branch line of the plurality of layer supply branch lines corresponding with one battery pack of the plurality of battery packs; and a layer return line fluidly coupled to a plurality of layer return branch lines in series, each layer return branch line of the plurality of layer return branch lines corresponding with one battery pack of the plurality of battery packs.

Aspect 43 is the layered battery pack module of any of Aspects 9-15, further comprising battery cabling lines, the battery cabling lines comprising: a primary cabling line; a plurality of layer cabling lines electronically coupled to the primary cabling line in parallel, each layer cabling line of the plurality of layer cabling lines correspond to one battery pack layer of the plurality of battery pack layers.

Aspect 44 is the layered battery pack module of Aspect 43, wherein each layer cabling line of the plurality of layer cabling lines corresponds to one battery pack layer of the plurality of battery pack layers and electronically couples to one battery pack of the plurality of battery packs such that the plurality of battery packs within one common battery pack layer of the plurality of battery pack layers are connected in parallel.

Aspect 45 is the layered battery pack module of any of Aspects 9-15, wherein the layered battery pack module has a unibody design.

Aspect 46 is a vehicle having a layered battery pack module, the vehicle comprising: a first wheel coupled to a first side of a chassis at a first forward position; a second wheel coupled to the first side of the chassis at a first rearward position; a support structure of a battery pack module coupled to the first side of the chassis at a position between the first wheel and the second wheel, the battery pack module including a plurality of battery pack layers in a vertical arrangement, each battery pack layer of the plurality of battery pack layers including at least one battery pack, wherein each battery pack layer of the plurality of battery pack layers includes a tray operating line, each tray operating line coupled to each battery pack of the at least one battery pack of the corresponding battery pack layer, and each tray operating line extending to a first end of the battery pack module; and a vertical operating cable extending vertically along at least a portion of the first end of the battery pack module to a first access point; wherein the first access point is positioned within an access zone defined behind the first wheel.

Aspect 47 is the vehicle of Aspect 46, wherein each battery pack layer includes a plurality of battery packs, and each tray operating line couples each battery pack of the plurality of battery packs of the corresponding battery pack layer in series.

Aspect 48 is the vehicle of Aspect 46, wherein each battery pack layer includes a plurality of battery packs, and each tray operating line couples each battery pack of the plurality of battery packs of the corresponding battery pack layer in parallel.

Aspect 49 is the vehicle of any one of Aspects 46-48, wherein each tray operating line and the vertical operating cable are electronic cabling lines.

Aspect 50 is the vehicle of Aspect 49, wherein each tray operating line is coupled to the vertical operating cable via a high voltage electrical interface box.

Aspect 51 is the vehicle of any one of Aspects 56-50, wherein the first access point is a high voltage electrical box.

Aspect 52 is the vehicle of any one of Aspects 46-51, wherein the first access point is positioned on an upper mounting surface of the battery pack module.

Aspect 53 is the vehicle of any one of Aspects 46-49, wherein each tray operating line and the vertical operating cable are cooling lines.

Aspect 54 is the vehicle of any one of Aspects 46-53, wherein the access point is accessible from the access zone via a removable service panel of the battery pack module.

Aspect 55 is a battery pack module for a vehicle, the battery pack module comprising: a front panel; a back panel positioned opposite of the front panel; a first side panel extending between the front panel and the back panel, the first side panel having a first service access; and a plurality of battery pack layers in a vertical arrangement within the front panel, the back panel, and the first side panel, each battery pack layer of the plurality of battery pack layers including a battery pack, wherein each battery pack layer of the plurality of battery pack layers includes a tray operating line, the tray operating line removably coupled to the battery pack and being accessible via the first service access for disconnecting the tray operating line from the battery pack.

Aspect 56 is the battery pack module of Aspect 55, wherein the service access is one of a door, a portal, or a flap.

Aspect 57 is the battery pack module of either Aspect 55 or Aspect 56, further comprising: a second side panel extending between the front panel and the back panel opposite the first side panel; a top panel extending between the front panel, the back panel, the first side panel, and the second side panel; and a second access corresponding with one of the front panel, the back panel, the second side panel, and the top panel.

Aspect 58 is the battery pack module of any one of Aspects 55-57, wherein the tray operating line extends to a first end of the battery pack module.

Aspect 59 is the battery pack module of Aspect 58, further comprising a vertical operating cable extending vertically along at least a portion of the first end of the battery pack module to a third access.

Aspect 60 is the battery pack module of any one of Aspects 55-59, wherein each battery pack layer includes a plurality of battery packs, and the tray operating line couples each battery pack of the plurality of battery packs of the corresponding battery pack layer in series.

Aspect 61 is the battery pack module of any one of Aspects 55-59, wherein each battery pack layer includes a plurality of battery packs, and the tray operating line couples each battery pack of the plurality of battery packs of the corresponding battery pack layer in parallel.

Aspect 62 is the battery pack module of any one of Aspects 55-61, wherein the tray operating line is an electronic cabling line.

Aspect 63 is the battery pack module of any one of Aspects 55-61, wherein the tray operating line includes: a layer supply branch cooling line fluidly coupled to a layer supply cooling line, the layer supply cooling line corresponding with a battery pack layer of the plurality of battery pack layers; and a layer return branch cooling line fluidly coupled to a layer return cooling line, the layer return cooling line corresponding with the battery pack layer of the plurality of battery pack layers.

Aspect 64 is the battery pack of Aspect 63, wherein the battery pack layer includes a plurality of battery packs, a plurality of layer supply branch cooling lines, and a plurality of layer return branch cooling lines so that: each layer supply branch cooling line of the plurality of layer supply branch cooling lines corresponds with one battery pack of the plurality of battery packs; each layer return branch cooling line of the plurality of layer return branch cooling lines corresponds with one battery pack of the plurality of battery packs; the layer supply cooling line is fluidly coupled to each layer supply branch cooling line of the plurality of layer supply branch cooling lines; and the layer return cooling line is fluidly coupled to each layer return branch cooling line of the plurality of layer return branch cooling lines.

Aspect 65 is the battery pack module of either Aspect 63 or Aspect 64, further comprising: a primary cooling supply line, the primary cooling supply line fluidly coupled to a coolant fluid source and the layer supply cooling line; and a primary cooling return line, the primary cooling return line fluidly coupled to the layer supply cooling line.

Aspect 66 is a battery pack tray for a layered battery pack module, the battery pack tray comprising: a tray, the tray comprising a tray surface, a distal end, a proximal end, a first side, and a second side, the tray configured to support at least one battery pack on the tray surface, the first side comprising a first sliding surface, and the second side comprising a second sliding surface; a first end plate coupled to the distal end of the tray and extending in a direction perpendicular to the tray surface; and a second end plate coupled to the proximal end of the tray; wherein the first end plate and the second end plate each comprise a stiffening lip that extends from the first end plate and the second end plate parallel to the tray surface.

Aspect 67 is the battery pack tray of Aspect 66, wherein the battery pack tray is configured to slide into a layered battery pack module on the first sliding surface and the second sliding surface.

Aspect 68 is the battery pack tray of either Aspect 66 or Aspect 67, wherein the first sliding surface is defined by a first sliding rail and the second sliding surface is defined by a second sliding rail.

Aspect 69 is the battery pack tray of any one of Aspects 66-68, wherein each of the first end plate and the second end plate comprise a tray lifting opening.

Aspect 70 is the battery pack tray of any one of Aspects 66-69, further comprising a first stiffening ridge extending a length of the first side of the tray between the distal end of the tray and the proximal end of the tray, and a second stiffening ridge extending a length of the second side of the tray between the distal end of the tray and the proximal end of the tray.

Aspect 71 is the battery pack tray of any one of Aspects 66-70, wherein the tray surface comprises a first tray support joist extending between the distal end of the tray and the proximal end of the tray and a second tray support joist extending between the first side of the tray and the second side of the tray.

Aspect 72 is the battery pack tray of Aspect 71, wherein the first tray support joist and the second tray support joist define a plurality of tray surface openings, the tray surface openings configured to allow fluid to drain through the slidable battery pack tray.

Aspect 73 is the battery pack tray of either Aspect 71 or Aspect 72, wherein the first tray support joist and the second tray support joist are included in a plurality of tray support joists, the plurality of tray support joists forming a lattice structure across the tray surface.

Aspect 74 is the battery pack tray of any one of Aspects 66-73, further comprising a cooling line mounting bracket configured to support a parallel cooling line, the parallel cooling line coupling to the at least one battery pack on the tray surface.

Aspect 75 is the battery pack tray of any one of Aspects 66-74, further comprising a high voltage electrical interface box configured to couple to a parallel cabling line coupled to the at least one battery pack on the tray surface.

Aspect 76 is a battery pack module for a mining truck, the layered battery pack module comprising: a plurality of battery pack trays, each battery pack tray of the plurality of battery pack trays removably coupled to a corresponding battery pack layer of a plurality of battery pack layers, each battery pack tray of the plurality of battery pack trays including at least one battery pack; a coolant line system configured to cool the at least one battery pack, the coolant line system comprising: a primary supply cooling line, the primary supply cooling line fluidly coupled to a coolant fluid source; a primary return cooling line; and a plurality of battery pack layer cooling lines fluidly coupled to the primary supply cooling line and the primary return cooling line, each one of the plurality of battery pack layer cooling lines corresponding to one battery pack layer of the plurality of battery pack layers; and a battery cabling system configured to transport current from the at least one battery pack of each battery pack layer of the plurality of battery pack layers to the mining truck, the battery cabling system comprising; a primary cabling line; and a plurality of layer cabling lines electronically coupled to the primary cabling line, each of the plurality of layer cabling lines corresponding to one battery pack layer of the plurality of battery pack layers.

Aspect 77 is the layered battery pack module of Aspect 76, wherein each battery pack layer cooling line of the plurality of battery pack layer cooling lines is fluidly coupled to the primary supply cooling line and the primary return cooling line in parallel.

Aspect 78 is the layered battery pack module of Aspect 76, wherein each battery pack layer cooling line of the plurality of battery pack layer cooling lines is fluidly coupled to the primary supply cooling line and the primary return cooling line in series.

Aspect 79 is the layered battery pack module of any one of Aspects 76-78, wherein each layer cabling line of the plurality of layer cabling lines is electronically coupled to the primary cabling line in parallel.

Aspect 80 is the layered battery pack module of any one of Aspects 76-78, wherein each layer cabling line of the plurality of layer cabling lines is electronically coupled to the primary cabling line in series.

Aspect 81 is the layered battery pack module of any one of Aspects 76-80, wherein each battery pack tray of the plurality of battery pack trays each comprise: a battery tray surface, the tray surface defined by: a first side; a second side parallel to the first side; a distal end connecting the first side to the second side; and a proximal end connecting the first side to the second side, the proximal end spaced apart from the distal end by the first side and the second side; and a plurality of battery support joists, the plurality of support joists extending from at least one of: the first side to the second side; and the distal end to the proximal end.

Aspect 82 is the layered battery pack module of Aspect 81, wherein the at least one battery pack is coupled to at least one battery support joists of the plurality of battery support joists.

Aspect 83 is the layered battery pack module of any one of Aspects 76-82, wherein each battery pack layer includes a plurality of battery packs and each battery pack layer cooling line of the plurality of battery pack layer cooling lines comprises: a layer supply line fluidly coupled to a plurality of layer supply branch lines in parallel, each of the plurality of layer supply branch lines corresponding with one battery pack of the plurality of battery packs; and a layer return line fluidly coupled to a plurality of layer return branch lines in parallel, each of the plurality of layer return branch lines corresponding with one battery pack of the plurality of battery packs.

Aspect 84 is the layered battery pack module of any one of Aspects 76-82, wherein each battery pack layer includes a plurality of battery packs and each battery pack layer cooling line of the plurality of battery pack layer cooling lines comprises: a layer supply line fluidly coupled to a plurality of layer supply branch lines in series, each of the plurality of layer supply branch lines corresponding with one battery pack of the plurality of battery packs; and a layer return line fluidly coupled to a plurality of layer return branch lines in series, each of the plurality of layer return branch lines corresponding with one battery pack of the plurality of battery packs.

Aspect 85 is the layered battery pack module of any one of Aspects 76-84, wherein each battery pack layer includes a plurality of battery packs and each layer cabling line of the plurality of layer cabling lines electronically couples the plurality of battery packs in parallel.

Aspect 86 is the layered battery pack module of any one of Aspects 76-84, wherein each battery pack layer includes a plurality of battery packs and each layer cabling line of the plurality of layer cabling lines electronically couples the plurality of battery packs in series.

Aspect 87 is a method of servicing a layered battery pack module on a mining truck, the method comprising: removing a first services access panel from a first side of the layered battery pack module; disconnecting a battery cabling from a high voltage electrical interface box of a first battery pack layer, which interrupts current flowing from any one battery pack of a plurality of battery packs on a battery pack tray of the first battery pack layer; removing an end service access panel from a front side of the layered battery pack module; and sliding the battery pack tray out of the layered battery pack module.

Aspect 88 is the method of Aspect 87, further comprising uncoupling a tray locking plate from a battery pack tray end plate.

Aspect 89 is the method of either Aspect 87 or Aspect 88, further comprising at least one of: sliding the battery pack tray into the battery pack module; coupling a tray locking plate to a battery pack tray end plate; coupling the end service access panel to the front side of the layered battery pack module; electronically connecting the battery cabling to the high voltage electrical interface box of the first battery pack layer; and coupling the first service access panel to the first side of the layered battery pack module.

Aspect 90 is the method of any one of Aspects 87-89, further comprising removing a second service access panel from at least one of a second side or a top side of the layered battery pack module.

Aspect 91 is the method of any one of Aspects 87-90, wherein sliding the battery pack tray out of the layered battery pack module comprises: inserting a tool into a lifting feature on a distal end of the battery pack tray; and using the tool to slide the battery pack tray out of the battery pack module.

What is claimed is:

1. A vehicle having a layered battery pack module, the vehicle comprising:
a first wheel coupled to a first side of a chassis at a first forward position;
a second wheel coupled to the first side of the chassis at a first rearward position;
a support structure of a battery pack module coupled to the first side of the chassis at a position between the first wheel and the second wheel, the battery pack module including a plurality of battery pack layers in a vertical arrangement, each battery pack layer of the plurality of battery pack layers including at least one battery pack, wherein each battery pack layer of the plurality of battery pack layers includes a tray operating line, each tray operating line coupled to each battery pack of the at least one battery pack of the corresponding battery pack layer, and each tray operating line extending to a first end of the battery pack module; and
a vertical operating cable extending vertically along at least a portion of the first end of the battery pack module to a first access point;
wherein the first access point is positioned within an access zone defined behind the first wheel.

2. The vehicle of claim 1, wherein each battery pack layer includes a plurality of battery packs, and each tray operating line couples each battery pack of the plurality of battery packs of the corresponding battery pack layer in series.

3. The vehicle of claim 1, wherein each battery pack layer includes a plurality of battery packs, and each tray operating line couples each battery pack of the plurality of battery packs of the corresponding battery pack layer in parallel.

4. The vehicle of claim 1, wherein each tray operating line and the vertical operating cable are electronic cabling lines.

5. The vehicle of claim 4, wherein each tray operating line is coupled to the vertical operating cable via a high voltage electrical interface box.

6. The vehicle of claim 1, wherein the first access point is a high voltage electrical box.

7. The vehicle of claim 1, wherein the first access point is positioned on an upper mounting surface of the battery pack module.

8. The vehicle of claim 1, wherein each tray operating line and the vertical operating cable are cooling lines.

9. The vehicle of claim 1, wherein the access point is accessible from the access zone via a removable service panel of the battery pack module.

10. A battery pack module for a vehicle, the battery pack module comprising:
a front panel;
a back panel positioned opposite of the front panel;
a first side panel extending between the front panel and the back panel, the first side panel having a first service access; and
a plurality of battery pack layers in a vertical arrangement within the front panel, the back panel, and the first side panel, each battery pack layer of the plurality of battery pack layers including a battery pack, wherein each battery pack layer of the plurality of battery pack layers includes a tray operating line, the tray operating line removably coupled to the battery pack and being accessible via the first service access for disconnecting the tray operating line from the battery pack.

11. The battery pack module of claim 10, wherein the service access is one of a door, a portal, or a flap.

12. The battery pack module of claim 10, further comprising:
a second side panel extending between the front panel and the back panel opposite the first side panel;
a top panel extending between the front panel, the back panel, the first side panel, and the second side panel; and
a second access corresponding with one of the front panel, the back panel, the second side panel, and the top panel.

13. The battery pack module of claim 10, wherein the tray operating line extends to a first end of the battery pack module.

14. The battery pack module of claim 13, further comprising a vertical operating cable extending vertically along at least a portion of the first end of the battery pack module to a third access.

15. The battery pack module of claim 10, wherein each battery pack layer includes a plurality of battery packs, and the tray operating line couples each battery pack of the plurality of battery packs of the corresponding battery pack layer in series.

16. The battery pack module of claim 10, wherein each battery pack layer includes a plurality of battery packs, and the tray operating line couples each battery pack of the plurality of battery packs of the corresponding battery pack layer in parallel.

17. The battery pack module of claim 10, wherein the tray operating line is an electronic cabling line.

18. The battery pack module of claim 10, wherein the tray operating line includes:
a layer supply branch cooling line fluidly coupled to a layer supply cooling line, the layer supply cooling line corresponding with a battery pack layer of the plurality of battery pack layers; and
a layer return branch cooling line fluidly coupled to a layer return cooling line, the layer return cooling line corresponding with the battery pack layer of the plurality of battery pack layers.

19. The battery pack module of claim 18, wherein the battery pack layer includes a plurality of battery packs, a plurality of layer supply branch cooling lines, and a plurality of layer return branch cooling lines so that:
each layer supply branch cooling line of the plurality of layer supply branch cooling lines corresponds with one battery pack of the plurality of battery packs;
each layer return branch cooling line of the plurality of layer return branch cooling lines corresponds with one battery pack of the plurality of battery packs;
the layer supply cooling line is fluidly coupled to each layer supply branch cooling line of the plurality of layer supply branch cooling lines; and
the layer return cooling line is fluidly coupled to each layer return branch cooling line of the plurality of layer return branch cooling lines.

20. The battery pack module of claim 18, further comprising:
a primary cooling supply line, the primary cooling supply line fluidly coupled to a coolant fluid source and the layer supply cooling line; and
a primary cooling return line, the primary cooling return line fluidly coupled to the layer supply cooling line.
